(19) United States
(12) Patent Application Publication
(10) Pub. No.: US 2026/0003815 A1
(43) Pub. Date: Jan. 1, 2026

(54) EMULATION AND AUTONOMOUS DEVICE MANAGEMENT OF EMBEDDED DEVICES OPERATING ON VARIOUS INTERCONNECTS VIA A MULTI-DEVICE HOST CONTROLLER

(71) Applicant: Intel Corporation, Santa Clara, CA (US)

(72) Inventors: Aruni P. Nelson, Rocklin, CA (US); Abdul R. Ismail, Beaverton, OR (US); Ashok Mishra, Portland, OR (US)

(73) Assignee: Intel Corporation, Santa Clara, CA (US)

(21) Appl. No.: 18/759,822

(22) Filed: Jun. 29, 2024

(51) Int. Cl. G06F 13/38; G06F 9/455; G06F 13/42

(52) U.S. Cl. CPC G06F 13/382; G06F 9/45508; G06F 13/4282

(57) ABSTRACT

Technologies disclosed herein provide for a multi-device host controller to emulate a first embedded device of a plurality of embedded devices of a computing system. Emulating an embedded device includes generating a descriptor based on a Universal Serial Bus (USB) protocol and on peripheral configuration information associated with the first embedded device. The peripheral configuration information is pre-programmed for the multi-device host controller. The multi-device host controller provides the first descriptor to a software stack running on a processor of the computing system. The first embedded device operates according to a Universal Serial Bus (USB) protocol or a non-USB protocol. The multi-device host controller can further take an action to autonomously manage the first embedded device based on one or more inputs received from one or more other embedded devices connected to the multi-device host controller.

### BACKGROUND

As technology evolves, computing devices offer increasingly more features and functionalities. New features and functionalities are often paired with the addition of displays, sensors, cameras, microphones, and other devices. Many of these devices are embedded in a computing device and employ various communication protocols, have different wiring requirements, controllers, and user mode software. Consequently, as more and more embedded devices are added to a computing device, the hardware footprint in the computing device continues to increase and consumes precious real estate on the motherboard.

### BRIEF DESCRIPTION OF THE DRAWINGS

FIG. 1 is a block diagram illustrating an example computing system providing a multi-device host controller of a Universal Serial Bus (USB) subsystem to emulate embedded devices operating on various interconnects and selectively perform autonomous device management according to at least one embodiment.

FIG. 2 is a block diagram illustrating additional example details of an embedded device emulator of the multi-device host controller of FIG. 1 according to at least one embodiment.

FIG. 3 is a block diagram illustrating a computing system providing a multi-device host controller of a USB subsystem to emulate an embedded display operating on an embedded Universal Serial Bus 2 version 2 (eUSB2v2) interconnect according to at least one embodiment.

FIG. 4 is a block diagram illustrating a computing system providing a multi-device host controller of a USB subsystem to emulate an improved inter integrated circuit (I3C device) via an I3C bus according to at least one embodiment.

FIG. 5 is a block diagram of a computing system and a flow diagram illustrating an example process of a multi-device host controller and a USB software stack in the computing system according to at least one embodiment.

FIGS. 6A and 6B are flow diagrams illustrating another example process of a multi-device host controller and a USB software stack according to at least one embodiment.

FIG. 7 illustrates an example processor.

FIG. 8 illustrates an example computing system.

### DETAILED DESCRIPTION

The present disclosure provides various possible embodiments, or examples, of systems, methods, apparatuses, architectures, and machine readable media for usage of a multi-device host controller and a USB software stack to enable emulation of embedded devices operating on various interconnects and selective autonomous device management of the embedded devices. The multi-device host controller can include at least some existing capabilities and functionalities of a USB host controller and additional capabilities and functionalities to accommodate the multiple embedded devices operating on various interconnects, emulation of the multiple embedded devices, and autonomous device management of one or more of the multiple embedded devices. Generally, embodiments of a multi-device host controller, USB software stack, and embedded devices using various communication protocols, as described herein may be implemented in a computing system such as a laptop, personal computer, tablet, desktop, or any other computing system that includes, or is configured to include, a multi-device host controller and USB software stack. In one or more examples, a multi-device host controller is configured to reduce the hardware footprint of embedded devices by emulating such communications with the embedded devices and reusing an existing USB stack with minimal or no changes.

For purposes of illustrating the several embodiments in this disclosure, the following contextual information is provided to illustrate the challenges of implementing input/output devices in various computing systems. In typical laptop designs, for example, a base panel and at least one lid panel may be included with multiple input output (I/O) devices (e.g., microphone, camera, electric shutter, sensors, touch controller, etc.) embedded in the lid panel to perform a variety of functions and enable features of the computing system. Generally, a lid panel is intended to mean a member or portion (e.g., lid portion) of a computing device in which a screen for displaying electronic information or content is disposed. A base panel is intended to mean a member or portion (e.g., base portion) of a computing device in which computing hardware (e.g., processor, CPU, motherboard, SOC, etc.) is disposed. A screen may or may not be disposed in a base panel.

As used in this specification, “input/output device” or “I/O device” is intended to include any device that is communicatively coupled to a processor and that can communicate with the processor. An I/O device can be capable of sending messages to the processor (e.g., an output device), receiving messages from the processor (e.g., an input device), or both sending messages to and receiving messages from the processor.

In this specification, references to an “embedded I/O device” are intended to mean an always-connected computing device or peripheral that is implemented in a panel, member, or other portion of a larger computing system (e.g., laptop, desktop, mobile device, smart phone, etc.) and that is communicatively coupled to a processor of the computing system. Embedded I/O devices may perform a variety of functions (e.g., specialized or dedicated functions or tasks) and enable features of the computing system. Examples of embedded I/O devices include, but are not necessarily limited to display devices, microphones, cameras, electric shutters, sensors, touch controllers, etc.).

A processor and an embedded I/O device may be implemented in the same (or different) panel, member, or portion of a computing system. Messages that are communicated between the embedded I/O device and the processor may depend on the particular communication protocol that is used, and may include one or more of read/write data, configuration information, initialization information, interrupts or interrupt-related information, data transfer start information, data transfer stop information, other data transfer information, etc., or any suitable combination thereof. It should be apparent that a computing system may include any number of processors and any number of embedded I/O devices based on the needs and requirements of the particular computing system in which the processor(s) and embedded I/O device(s) are implemented.

Various protocols may be used to communicate messages between a processor in a computing system and different embedded I/O devices in the computing system. Common protocols used for communications between a processor and many embedded I/O devices may include, but are not necessarily limited to, an Improved Inter Integrated Circuit (I3C), a serial peripheral interface (SPI), and/or a general purpose input/output (GPIO). These communication protocols are used to transport low-speed input/output (I/O) signals across their respective communication links (e.g., I3C bus, SPI bus, GPIO wire(s)) communicatively coupled to the processor. Some embedded I/O devices (e.g., embedded display devices, embedded cameras, etc.), however, employ high speed I/O buses, such as a universal serial bus (USB), for communication with a processor.

A general description of USB, I2C, SPI, and GPIO protocols is now provided. Universal Serial Bus (USB) is an industry-standard specification for data exchange and delivery of power between many types of electronics including, but not limited to central processing units (CPUs), graphics processing units (GPUs), multi-core processors, quantum processors, systems-on-a-chip (SOCs), microprocessors, microcontrollers, embedded processors, various other types of processors, embedded I/O devices (e.g., internal peripheral devices), external peripheral devices, etc. The “USB 2.0 Specification,” USB Implementers Forum, Inc. (Apr. 27, 2000), is used in many applications.

Generally, the USB protocol includes a high speed I/O bus for data transfers, a USB host controller, and a USB stack (e.g., user mode device driver, kernel mode driver stack). The USB 2.0 protocol provides a minimum data transfer rate of 480 Mega bits per second (Mbps) for USB 2.0, and USB 3.0 provides a minimum data transfer rate of 4.8 gigabits per second (Gbit/s). Some embedded USB display device are connected to a USB host controller (e.g., via a USB-C connector) and are further connected to one or more pipes (e.g., logical connections) of a display engine via physical phase-locked loop (PHY PLL) pin connectors, which are used to transmit the display data to the embedded display device. The host controller is communicatively coupled to the processor on which a USB user mode software stack for the embedded display device and a USB kernel mode driver stack run. A wide connector having, for example, 30-40 embedded display (eDP) pin connectors, is commonly used within the computing system to connect the display engine to the display device. In addition to the significant number of pin connectors traversing the system, negotiations over the PHY PLLs also occur when the display device powers on, for example.

A supplement to USB 2.0 allows USB 2.0 devices to be embedded in other devices. Presently eUSB2 Version 2.0 (eUSB2V2) is being defined in USB Implementers Forum, Inc, which provides performance enhancement to the Embedded USB2 (eUSB2) Physical Layer Supplement to the USB Revision 2.0 Specification, Rev. 1.2, by adding significantly higher data rates to USB 2.0, while maintaining a low-voltage electrical interface. The eUSB2v2 specification defines a low voltage, power efficient eUSB2v2 PHY layer solution for interface controller integration with advanced system-on-chip (SoC) process nodes. Protocol behavior for eUSB2v2 is the same as defined in the USB 2.0 specification.

USB descriptors, such as standard device descriptors and class/vendor specific descriptors, can be embodied as structures containing information related to a USB device. Standard device descriptors may include device descriptors, configuration descriptors, interface descriptors, and endpoint descriptors. Generally, standard device descriptors provide information about a USB device to the host system to enable identification and proper configuration of the device. Typically, USB descriptors are exposed by a USB device or a portion thereof, to a USB host controller. For example, each USB device exposes a device descriptor, which can include identification of the USB version that is supported, vendor identifier, product identifier, the number of possible configurations the device can have. Each configuration exposes a configuration descriptor that describes the particular configuration of the device (e.g., power requirements, number of interfaces, etc.). Each interface exposes an interface descriptor that includes details about the interface (e.g., the number of endpoints used by the interface, interface class code, etc.). Each endpoint within an interface exposes an endpoint descriptor that includes information about the endpoint (e.g., address, endpoint type, maximum packet size, etc.).

Some USB devices may also expose class-specific descriptors and/or vendor-specific descriptors. Class-specific descriptors provide additional information specific to the device class to enable the host to correctly interact with the device. Examples of specific USB device classes include, but are not necessarily limited to, Human Interface Device (HID), mass storage, and audio. Vendor-specific descriptors may be used for devices with functionalities that are not covered by standard USB classes. Information contained in vendor-specific descriptors may be defined by the device manufacturer and may be used to ensure proper communication between the device and the host.

An endpoint is a buffer on a USB device and the host (e.g., processor) can send and receive data to or from that buffer. A control endpoint is provided for every USB device and is used for device setup and control commands. A control transfer allows the host to obtain device information, configure the device, or perform control operations for the device. Bulk endpoints allow large, non-time-sensitive data transfers with error detection and recovery between the host and the device. Examples of typical uses of bulk endpoints include printers, storage devices, and network adapters. Isochronous (Isoch) endpoints are used for time-sensitive data transfers with fixed latency and no error correction. Examples of typical uses of isoch interrupts include streaming audio and video data. Interrupt endpoints are used for sending small amounts of data that require timely delivery, such as status updates or user inputs. These endpoints can be polled at regular intervals by the host. Examples of typical uses of interrupt endpoints include keyboards, mice, and other input devices needing attention from the host.

Typically, a USB host controller detects an embedded USB device and informs the host (e.g., CPU). The host initiates the enumeration process by sending requests for USB descriptors (e.g., control transfer requests) through the USB host controller to the embedded USB device. The host controller executes the requests and facilitates data transfers between the host and the embedded USB device. For example, a host initiates a series of standard requests to the device's control endpoint to obtain the standard USB device descriptors. Class-specific descriptors and vendor-specific descriptors can be exposed through a sequence of standard USB requests during the device enumeration process. The host can issue specific requests to obtain the class-specific and/or vendor-specific descriptors to enable proper interaction and communication with the device. These requests from the host are sent to the embedded USB device by the host controller, and the device responds by sending the requested descriptor to the host controller. The host controller can forward the received descriptor to the host.

An Improved Inter Integrated Circuit (I3C) is a Mobile Industry Processor Interface (MIPI) specification to enable communication between computer chips and are used for communication between certain devices (referred to herein as “I3C devices” or “embedded I3C devices”) that are embedded in a computing system and one or more processors in that computing system. One version of the I3C standard is provided in “MIPI I3C® Specification, Version 1.1.1,” MIPI Alliance (Jun. 9, 2021). In I3C, a multi-controller/multi-target, packet-switched, single-ended, serial communication bus is used to attach lower-speed remote I/O devices (e.g., peripherals, sensors, touch controllers, etc.) in a computing system to a processor (e.g., a microcontroller, etc.) in the computing system. The I3C bus may contain two bi-directional wires, a serial data line (SDA) and a serial clock line (SCL), which are connected to all devices on the I3C bus. The devices on the I3C bus are either a controller device or a target device. Typically, one controller device and one or more target devices are connected to the I3C bus. The I3C protocol is improved over the Inter Integrated Circuit (I2C) protocol, as I3C utilizes a device addressing technique that is dynamic, a faster data transmission speed, and more efficient power consumption. The I2C protocol may be implemented using a system management bus (SMBus) defined by Intel Corp. and Duracell Corp.

A serial peripheral interface (SPI) is a full-duplex synchronous serial communication interface bus that is often used to attach lower-speed embedded I/O devices (e.g., small peripherals, sensors, touch controllers, etc.) in a computing system to a processor (e.g., microcontroller, etc.) in the computing system. The devices on the SPI bus include a single controller device and one or more target devices. The SPI bus includes four wires to carry four logic signals, which include a serial clock (SCLK), a data output from controller (MOSI), a data input from target (MISO), and a chip select (CS). While the SCLK, MOSI, and MISO lines can be shared by the two or more target devices, each target device may include a unique CS line that connects to the controller device.

A variety of protocol options are available for an SPI bus, which lacks a formal standard. An SPI bus can transport a certain number of bits at a time. For example, some devices transmit 8 bits (i.e., 1 byte) at a time, and some devices transmit 16 bits (i.e., 2 bytes) at a time. The full-duplex SPI bus allows bits of data to be communicated from a SPI controller device to a target device and vice versa at the same time. Using shift registers, bits can be shifted out of a controller device and into a target device, and at the same time, bits can be shifted out of the target device and into the SPI controller device.

A general purpose input/output (GPIO) is a signal pin (or interface) used to connect microcontrollers, such as a processor in a computing system, to other electronic devices, such as certain embedded I/O devices in the computing system. The purpose and behavior of a GPIO pin is customizable and can be controlled by software. GPIOs may be used for many different functions including, for example, controlling or monitoring other circuitry on a board, reading states of switches on a board, driving light-emitting diodes (LEDs) as status indicators, or as an interrupt for a device. In some examples, GPIO pins can be used in parallel with a bus of another protocol such as I3C or SPI. For example, a camera may use an I3C bus to transmit imaging data to the processor, in addition to two GPIO pins. One GPIO pin may be used to power the camera up/down and another GPIO pin may be used to drive a light-emitting diode (LED) to indicate whether the camera is activated.

Current implementations of embedded USB devices in laptops, personal computers, and other computing systems are based on the existence of a USB device controller and communication between a USB host controller and the USB device controller to configure and interact with USB I/O device. In cases where embedded I/O devices are connected on a different I/O bus, an I/O-specific device controller, an I/O-specific host controller, and an I/O-specific software stack to configure and interact with the I/O device are included in the computing system.

Certain peripherals such as embedded display devices, require a large number of pin connectors (e.g., 30-40 in some examples) resulting in a wide connector consuming significant space within the computing system and possibly across multiple panels in computing systems with two or more panels (e.g., laptops, mobile phones, etc.). Accordingly, reducing the number of I/O controllers in a computing system would free precious real estate within the system to allow for more functionality and design options. In addition, I/O controllers (e.g., USB host controller, I3C controller, SPI controller, etc.) negotiate across the connected wires to their respective embedded I/O devices. As the number of pin connectors or wires between an I/O controller and an embedded I/O device increases, the number of electrical signals between the I/O controller and the embedded I/O device increases to carry, for example, messages to negotiate with and configure the I/O device (e.g., communications to obtain USB descriptors from USB devices). These electrical signals may be significant as the number of embedded I/O devices increases and the size of the computing system decreases.

Embodiments disclosed herein can resolve the aforementioned issues (and more) associated with multiple I/O controllers used for I/O devices of a computing system and the communications related to negotiations and configuration between an I/O controller and a respective I/O device. In one or more examples, a multi-device host controller and appropriate software stack for embedded devices operating on various interconnects is provided. The multi-device host controller is configured to emulate device controllers for the embedded (always-connected) peripherals, which may include USB or other embedded devices on other I/O buses (e.g., MIPI, SMBus, I3C, etc.). In one or more examples herein, a USB software stack is reused to interact with embedded devices that use the USB link and protocol via a multi-device host controller, without requiring interactions with device controllers of each embedded USB device during enumeration (e.g., start-up). In addition, at least a portion (e.g., kernel mode) of the USB software stack is reused to interact with embedded devices on other I/O buses (also referred to herein as “non-USB embedded devices”) via the multi-device host controller, without requiring interactions with device controllers of the non-USB embedded devices during enumeration. Furthermore, the USB software stack can be reused for non-USB devices such as non-USB cameras, I3C/I2C devices, without a need for physical, dedicated (I/O-specific) host controllers for their respective buses. Additionally, the multi-device host controller may selectively perform autonomous device management for one or more embedded devices based on inputs from other embedded devices connected to the multi-device host controller.

In one or more embodiments, a multi-device host controller as disclosed herein can offer many advantages. Significantly, for embedded display devices operating on eUSB2v2, interaction with the embedded display panel during configuration can be reduced as the multi-device host controller responds, on behalf of the embedded display device, to USB display enumeration and configuration requests. Similarly, the interaction with other embedded I/O devices can be reduced as the USB host controller responds, on behalf of the embedded I/O device, to I/O device enumeration and configuration requests. It should be further noted that the concepts disclosed herein can be realized on any I/O bus connected behind a multi-device host controller.

For ease of explanation, some examples herein may be described in the context of eUSB2v2 and I3C. It should be apparent, however, that the concepts provided herein could be applicable to updated, revised, and/or new versions of USB standards including updated, revised, and/or new versions of USB standards for embedded devices. Additionally, the concepts provided herein could be realized on any I/O bus connected behind a USB host controller.

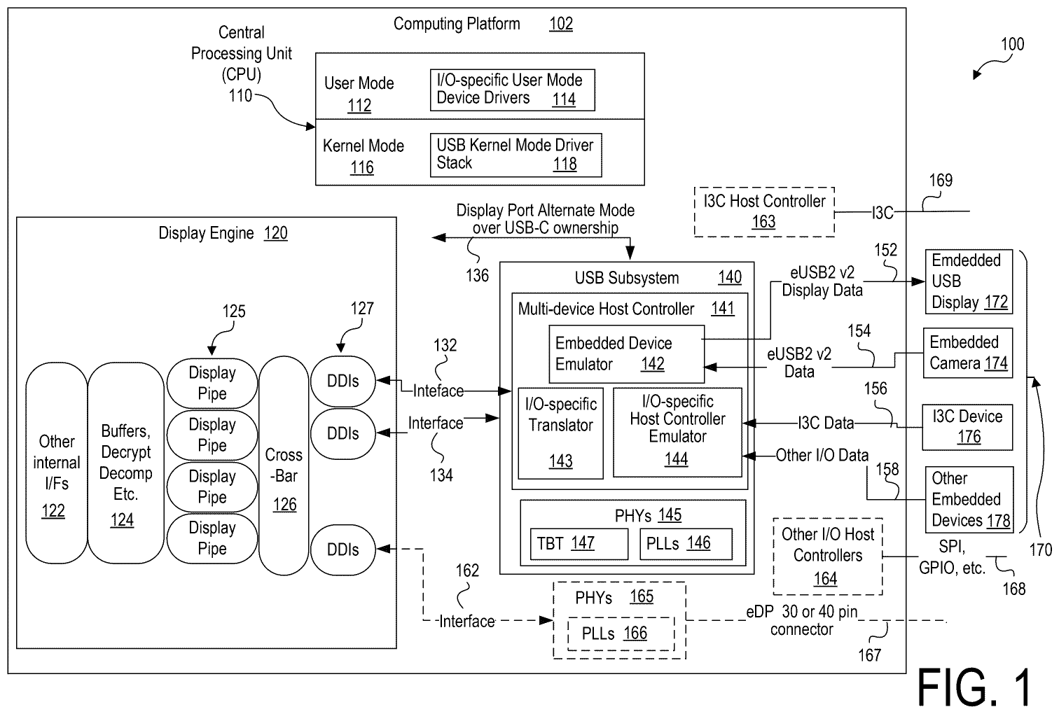

Reference is now made to the drawings. FIG. 1 is a generalized block diagram illustrating an example computing system 100 providing a multi-device host controller connected to embedded devices operating on various interconnects according to at least one embodiment. The example computing system 100 includes a computing platform 102 (e.g., a host machine) and embedded devices 170. The embedded devices may include multiple peripheral I/O devices that are embedded in a computing system and that operate on various interconnects including both USB-based protocols and non-USB-based protocols (e.g., I3C, SPI, GPIO, etc.). The embedded devices 170 of FIG. 1 include an embedded USB display 172, an embedded camera 174, an I3C device 176, and other embedded devices 178.

In the example FIG. 1, computing platform 102 includes a central processing unit (CPU) 110, a display engine 120, and a USB subsystem 140. In some scenarios, computing platform 102 may host an integrated circuit (IC) such as a system-on-chip (SoC), which integrates various hardware, software, firmware, or a suitable combination thereof of the computing platform 102 on a single chip. In one example implementation, the computing system 100 may be embodied as a laptop in which the computing platform 102 is disposed in a base panel and one or more of the embedded devices 170 are disposed in a lid panel that is movably (e.g., rotatably, pivotable, etc.) coupled to the base panel.

Display engine 120 of computing platform 102 is a specialized hardware component that may be embodied as a graphics processing unit (GPU) or graphics card. The display engine 120 is configured to render data such as images, animations, and video for output to a display. In this example, the display engine 120 generates data for and provides the data to the embedded USB display 172. More particularly, display engine 120 offloads graphics-intensive tasks from the CPU 110, decodes and encodes video streams, determines visual characteristics of pixels and vertices, and converts 2D and 3D models into images and animations. Some components of display engine 120 can include internal interfaces (I/Fs) 122, buffers, decryption, and decompression components 124, display pipes 125, a cross-bar 126, and digital display interfaces (DDIs) 127. I/O pipes are used to send the generated display data to embedded USB display 172.

Computing system 100 can include a variety of I/O devices using a variety of I/O protocols. In FIG. 1, embedded devices 170 include embedded USB display 172 (e.g., using eUSB2 v2 protocol), embedded camera 174 (e.g., using eUSB2 v2 protocol), I3C device 176 (e.g., sensors, electric shutters, MIPI cameras, etc. using I3C protocol), and other embedded devices 178. Nonlimiting examples of other embedded devices 178 could include microphones, light emitting diode (LED), a MIPI camera, and a Human Interface Device (HID). Various protocols such as I2C/I3C, GPIO, SPI, HID, and many others could be used. A HID device may include any device (typically hardware) that is configured to receive human input that interacts with a computing device and may provide output. Examples include, but are not limited to, a touch screen, keyboards and pointing devices, manual panel controls, simulation devices, webcams, gaming controllers, etc. The enumerated examples above are not exhaustive and it should be appreciated that any other peripheral devices, sensing modules, human interface devices, or any combination thereof may be added to computing system to support desired features and functionalities.

Using dashed lines, FIG. 1 illustrates some typical components and connections of the embedded devices that may be needed when a multi-device host controller for embedded devices 170, as disclosed herein, is not implemented in a computing system. In this typical scenario, embedded I/O devices using communication protocols other than USB have I/O-specific device controllers and I/O-specific host controllers. For example, the I3C device 176 could have an I3C device controller that is physically connected via appropriate buses/wires 169 to an I3C (host) controller 163, which is communicatively coupled to the CPU 110. In another example of a common system, other embedded devices 178 using other protocols (e.g., SPI, GPIO, etc.) have dedicated I/O-specific device controllers that are physically connected via appropriate buses/wires 168 to respective other I/O-specific (host) controllers 164. For embedded USB devices, each embedded USB device (e.g., embedded USB display 172, embedded camera 174) has a dedicated USB device controller that is physically connected via a USB bus to a USB host controller. The display engine 120, however, interfaces to the physical layer (PHY) 165 via an interface 162 (e.g., Physical Interface for the PCI Express and USB SuperSpeed Architectures (PIPE) or other suitable logical connection) to transmit the display data to the embedded USB display 172 via an embedded display port (eDP) 168. The physical layer 165 may include phase-locked loops (PLLs) 166 and typically has 30-40 pin connectors to carry the display data to the embedded USB display 172.

The implementation of a multi-device host controller and appropriate software stacks for embedded I/O devices using multiple communication protocols, as shown in computing system 100, enables the elimination of some hardware and connections, some of which are represented in dashed lines shown in FIG. 1 (e.g., 162, 163, 164, 165, 166, 167). Accordingly, in computing system 100, each of the embedded devices 170, which use various communication protocols, connects to CPU 110 in the computing platform 102 via a multi-device host controller 141 in a USB subsystem 140. The USB subsystem 140 may be a USB Type-C (USB-C), which accommodates multiple protocols such as USB 3.1, DisplayPort, mobile high-definition link (MHL), high-definition multimedia interface (HDMI), and USB4 (Thunderbolt™). The concepts described herein may also be used in conjunction with embedded I/O devices that communicate using older versions of USB (e.g., USB-A, USB-B, Micro-B, etc.) and possibly other versions of USB (and/or other communication protocols) not yet available.

In one or more examples, the multi-device host controller 141 can provide an interface to USB for embedded I/O devices using multiple communication protocols. The multi-device host controller 141 can be embodied as an integrated circuit with a microcontroller that facilitates communications to/from embedded devices 170 that are physically connected to the multi-device host controller 141 and further facilitates communications to/from the CPU 110. A physical layer (PHY) 145 provides a physical interface to a cable or other line (e.g., Physical Interface for the PCI Express and USB SuperSpeed Architectures (PIPE)).

Embedded devices using USB protocols can be physically connected to multi-device host controller 141. At least some of the USB embedded devices may communicate using eUSB2v2 protocols. For example, embedded USB display 172 can be physically connected to multi-device host controller 141 and receive eUSB2v2 display data 152 over the physical connection (e.g., an eUSB2v2 two-pin connector). The embedded camera 174 can be physically connected to multi-device host controller 141 and eUSB2v2 data 154 can be communicated over the physical connection (e.g., an eUSB2v2 two-pin connector).

The various embedded devices 170 operating on various interconnects (e.g., eUSB2 v2, I3C, SPI, GPIO, etc.) can also be physically connected to the multi-device host controller 141. For embedded devices that use protocols other than USB and that are physically connected to the multi-device host controller 141, the respective hardware I/O-specific host controllers (e.g., 163, 164) for those embedded devices can be omitted. For example, the I3C device 176 can be physically connected to multi-device host controller 141 and I3C data 156 can be communicated over the physical connection. Other embedded devices 178 using other non-USB protocols can each be physically connected to multi-device host controller 141 and the other (non-USB) I/O data 158 of the other embedded devices 178 can be communicated over the respective physical connections based on the respective protocols (e.g., SPI, GPIO, etc.).

The USB multi-device host controller 141 includes an I/O-specific host controller emulator 144 that can be configured as logic (e.g., firmware, software, hardware, or any suitable combination thereof) in multi-device host controller 141 to emulate a non-USB host controller (e.g., 163, 164) that has been omitted. In some examples, distinct I/O controller logic may be configured for each type of non-USB I/O communication protocol (e.g., I3C, SPI, GPIO, etc.) used by embedded devices 170 in computing system 100. In other examples, distinct I/O controller logic may be configured for each embedded non-USB I/O device (e.g., each embedded I3C device, each one of the other embedded devices 178, etc.) of the computing system 100.

The multi-device host controller 141 also includes an embedded device emulator 142, which can be configured as logic (e.g., firmware, software, hardware, or any suitable combination thereof) to emulate an I/O device controller of one or more embedded devices 170, respectively, connected to the multi-device host controller 141. In some examples, distinct embedded device emulator logic may be configured for each embedded device in the computing system 100.

The embedded device emulator 142 presents an embedded USB device or embedded non-USB device as a USB device to system software (e.g., USB kernel mode driver stack 118) without requiring interactions with a physical USB device controller. Because the embedded device emulator 142 is configured for an embedded device (e.g., an embedded USB device or an embedded non-USB device), which is known a priori to the computing system's integration, the multi-device host controller 141 can be pre-programmed to correctly represent the capabilities of the embedded device. Pre-programming the multi-device host controller 141 can be performed by the basic input/output system (BIOS) or another sideband mechanism at the system integration stage. Once pre-programmed with the appropriate device-specific information, the device emulator 142 can provide the capabilities of the connected embedded device and present a hot plug event (e.g., notification to software that something has changed in the system's configuration) to system software to indicate the presence of a new USB device, regardless of whether the embedded I/O device operates using USB or non-USB protocols. The embedded device emulator 142 can also respond to standard USB control transfers with a standard set of USB descriptors to describe a typical USB device, regardless of whether the embedded I/O device operates using USB or non-USB protocols.

In one or more examples, the multi-device host controller 141 is configured with an I/O-specific translator 143 for embedded I/O devices that operate using non-USB protocols (e.g., I3C, SPI, GPIO, etc.). An I/O-specific translator 143 can be configured as logic (e.g., firmware, software, hardware, or any suitable combination thereof) in multi-device host controller 141 to convert USB requests to I/O-specific transactions or messages. The I/O-specific transactions can be based on a non-USB communication protocol used by the particular embedded I/O device that is the target of the USB request.

The USB subsystem 140 includes a physical layer (PHY) 145 that can include phase-locked loops (PLLs) 146 for clock generation, frequency synthesis, data recovery, etc. The physical layer 145 may also include Thunderbolt (TBT) 147, which is a hardware interface allowing the connection of external peripheral devices using PCI Express (PCIe) and Display Port (DP) to transmit data and video signals in a tunneled display over the same cable (e.g., USB type-C 24-pin connector). In one or more examples, an interface 132 is provided to enable the display engine 120 to provide the eUSB2v2 display data to the multi-device host controller 141, which can be forwarded to the embedded USB display 172 over an eUSB2v2 line. In at least some scenarios, the interface 132 couples the multi-device host controller 141 to one or more DDIs 127 of the display engine 120. The interface 132 between the display engine 120 and the multi-device host controller 141 may be any suitable logical connection including, but not necessarily limited to a Physical Interface for the PCI Express and USB SuperSpeed Architectures (PIPE).

Optionally, another interface 134 (e.g., PIPE) may be provided from one of the DDIs 127 of the display engine 120 to the USB subsystem 140. The interface 134 allows display data to be sent from the display engine 120 to the USB subsystem 140, and then forwarded over the physical layer 145 via TBT 147 to provide the display data to a tunneled display and display port (not shown in FIG. 1). Another interface 136 (e.g., display port alternate mode over USBC-C ownership) may also allow communication between the USB subsystem 140 and the display engine 120

A USB software stack that runs on CPU 110 facilitates communication between applications and the embedded devices 170. The USB software stack can include some of the standard USB software existing for the embedded USB devices. For example, USB kernel mode driver stack 118 can include standard system software for USB that runs in kernel mode 116 on CPU 110. The USB kernel mode driver stack 118 can be used by embedded USB devices (e.g., 172 and 174) and by non-USB embedded devices (e.g., 176 and 178) that communicate with multi-device host controller 141. User mode software in the USB software stack includes I/O-specific user mode device drivers 114 that run in a user mode 112 on CPU 110. The I/O-specific user mode device drivers 114 can include existing USB class-based drivers for embedded USB devices (e.g., 172 and 174). The existing USB class-based drivers for embedded USB devices (e.g., 172 and 174) can continue to be used for communications between the CPU 110 and the embedded USB devices (e.g., 172, 174).

For different types of embedded I/O devices (e.g., non-USB devices such as I3C device, SPI device, GPIO device, etc.) that do not typically use existing USB class-based drivers, multi-device host controller 141, translates communications associated with non-USB devices from formats based on non-USB communication protocols to a format based on a USB protocol, and vice versa. Therefore, a new I/O-specific user mode driver can be configured on top of the USB software stack for each of those non-USB devices. Because data may be received at the CPU 110 from the embedded non-USB device according to the USB protocol, a new I/O-specific user mode device driver 114 can be configured to understand that the USB data is associated with the particular embedded non-USB device, and to appropriately consume and digest the received USB data from that embedded non-USB device. In some scenarios, the USB data may be translated back to the format based on the specific non-USB (e.g., I3C, SPI, GPIO, etc.) communication protocol associated with the embedded device.

Although one example implementation shown herein includes eUSB2V2 communication protocol for embedded displays and another example implementation shown herein includes an embedded I3C device, the concept can be realized on any I/O bus connected behind a USB host controller. Examples of other I/O communication protocols that may be used by embedded devices connected to a multi-device host controller as disclosed herein include, but are not necessarily limited to, SPI, GPIO, HID, I2C, I2S (Inter IC Sound), UART (Universal Asynchronous Receiver Transmitter), CAN (Controller Area Network), SDIO (Secure Digital IO), MIPI's CSI (Cameral Serial Interface), MIPI's DSI (Display Serial Interface), and more.

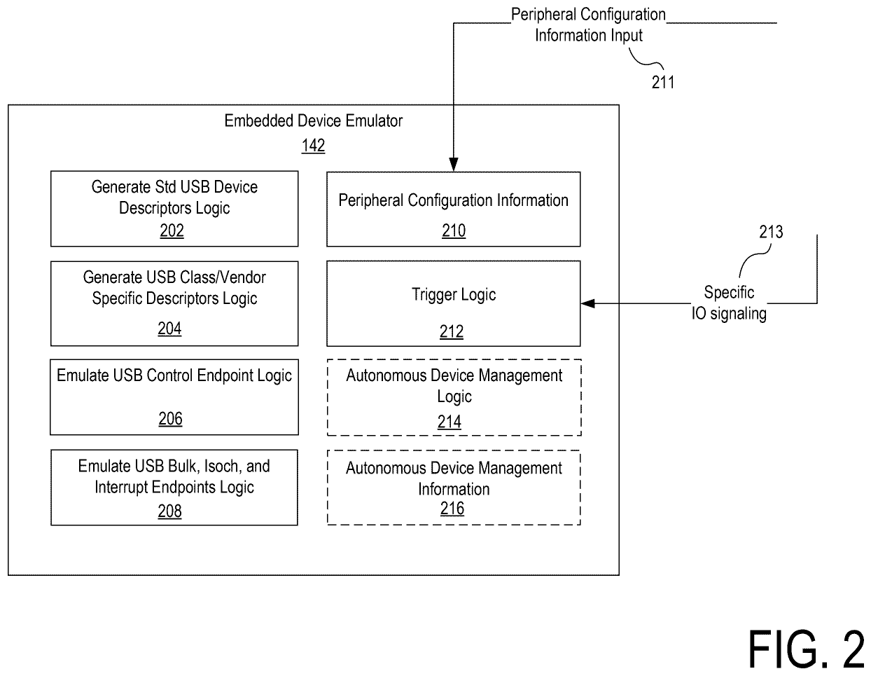

FIG. 2 is a block diagram of an example embedded device emulator 142 illustrating additional possible details. The details of embedded device emulator 142 shown in FIG. 2 illustrate one possible example of structure and logic of an embedded device emulator (e.g., embedded device emulators 142, 342, 442) included in a multi-device host controller (e.g., multi-device host controllers 141, 341, 441) in a computing system (e.g., computing systems 100, 300, 400) in various embodiments shown herein. The embedded device emulator 142 includes logic that may be implemented in the form of firmware, software, hardware, or any suitable combination thereof. For example, the embedded device emulator 142 may be configured to include generate standard USB device descriptors logic 202, generate USB class/vendor specific descriptors logic 204, emulate USB control endpoint logic 206, emulate USB bulk, isoch, and interrupt endpoints logic 208, trigger logic 212, and autonomous device management logic 214. The embedded device emulator 142 may also include some form of memory or storage to store peripheral configuration information 210. Registers or other types of memory or storage may also be included in the multi-device host controller 141 or otherwise accessible to the embedded device emulator 142 to support autonomous device management.

In one or more examples, a multi-device host controller (e.g., multi-device host controllers 141, 341, 441) is pre-programmed with peripheral configuration information 210 for each of the embedded devices that operates according to a USB protocol (e.g., eUSB2v2, Human Interface Device (HID), etc.) or another (non-USB) protocol (e.g., I3C, SPI, GPIO, etc.). The peripheral configuration information correctly represents the capabilities of the embedded devices. Example peripheral configuration information includes a list of devices that are embedded in the computing system and the capabilities of the embedded devices. Capabilities of the embedded devices are based, at least in part, on the type of device. Capabilities of standard devices (both USB devices and non-USB devices) are typically defined in their respective manufacturer's device specification. Capabilities of a USB embedded device can include information that is typically requested by a USB host controller from a USB embedded device and is received by the USB host controller from exposed descriptors (e.g., standard USB device descriptors, class/vendor specific descriptors) of the USB embedded device. Capabilities of a non-USB embedded device can include information related to the non-USB embedded device that corresponds to similar types of information contained in USB descriptors of USB devices, but that is instead specific to the non-USB embedded device.

The peripheral configuration can be determined at the design time of the platform, and the multi-device host controller may be pre-programmed with the appropriate peripheral configuration information by a suitable platform element during system integration of the platform. Peripheral configuration information input 211 can be stored in fuses or a configuration file of the computing system and can be sent to the multi-device host controller by platform firmware such a Basic Input/Output System (BIOS), or any other suitable sideband mechanism. The peripheral configuration information input 211 can be used to configure the peripheral configuration information 210 in memory, registers, or other storage of the multi-device host controller.

The peripheral configuration information 210 for an embedded device directly connected to the multi-device USB host controller contains details about the embedded device including, but not limited to a device (or product) identifier and a vendor identifier. In addition, the peripheral configuration information 210 includes the capabilities supported by the embedded device. For example, an eUSB2v2 embedded display may have an Extended Display Identification Data (EDID) or Display-ID (as defined by Video Electronics Standards Association) data structure describing the eUSB2v2 capabilities of embedded display. In another example, an I3C device can indicate capabilities through its bus characteristics register and device characteristics register (e.g., as defined in the MIPI I3C® Specification). The I3C capabilities may include, for example, the supported role of the device, the supported advanced capabilities, the supported in-band interrupt, device type, etc.

In one or more examples, the embedded device emulator 142 includes various logics to generate USB descriptors for both USB embedded devices and non-USB (e.g., I3C, SPI, GPIO, etc.) embedded devices. The logic 202 to generate standard USB device descriptors may be configured to generate standard USB device descriptors for an embedded device (e.g., USB device or non-USB device) without typical communications to the embedded device to request the standard USB device descriptors from a USB embedded device, or to request identification and configuration information from a non-USB embedded device. Instead, the information needed to generate standard USB device descriptors for the embedded devices can be obtained from the peripheral configuration information 210. The logic 204 to generate USB class/vendor specific descriptors may be configured to generate USB class/vendor specific descriptors for an embedded device (e.g., USB device or non-USB device) without typical communications to the embedded device to request the USB class/vendor specific descriptors from a USB embedded device, or to request specific class and/or vendor information from a non-USB embedded device. Instead, the information needed to generate USB class/vendor specific descriptors for the embedded devices can be obtained from the peripheral configuration information 210. In at least some examples, USB class/vendor specific descriptors may not be generated by logic 204 for non-USB devices.

In one or more examples, the embedded device emulator 142 includes various logic to emulate USB endpoints for both USB embedded devices and non-USB (e.g., I3C, SPI, GPIO, etc.) embedded devices. The logic 206 to emulate USB control endpoint may be configured to emulate a control endpoint for an embedded device (e.g., USB device or non-USB device) such that the host controller does not send a control transfer request received from the host to the embedded device. Instead, in response to the multi-device host controller receiving a control transfer request for an embedded device (e.g., USB device or non-USB device), the embedded device emulator 142 of the host controller may send the appropriate USB descriptor generated by the generate standard USB device descriptors logic 202 or the generate USB class/vendor specific descriptors logic 204. The appropriate capabilities (e.g., descriptor) are sent to the host by the multi-device USB host controller without communicating with the embedded device. Based on the design of the USB subsystem, the capabilities may be shared either through the control endpoint (e.g., by the emulate USB control endpoint logic 206) or through the bulk endpoint (e.g., by the emulate USB bulk, isoch, and interrupt endpoints logic 208).

The embedded device emulator 142 can also include trigger logic 212, which is configured to enable the multi-device host controller to detect embedded devices (e.g., USB devices and non-USB devices) that are directly connected to the multi-device host controller via based on specific I/O signaling 213. Specific I/O signaling 213 for an I/O device is typically defined in the standard IO specifications and in some cases in the manufacturer's specification for the I/O device. The specific I/O signaling 213 for an I/O device may be based on the type of the I/O device, the I/O wires over which the device is connected to the multi-device host controller, and/or any other criteria defined in the standard IO specifications and/or manufacturer's specification for that I/O device. For example, a connected eUSB2v2 device (e.g., camera, display, other eUSB2v2 devices) can be detected when the device has pulled the eD+ or eD− data line high through a 1.5 kΩ resistor. In another example, a connected I3C device can be detected when the I3C device sends a special interrupt request with a reserved I3C address. In yet another example, a connected I2C device can be detected when that device pulls the Serial Data (SDA) line low. Additionally, trigger logic 212 may be configured to initiate the embedded device emulator 142 once an embedded device has been detected. Emulator operations can begin once the embedded device emulator 142

Optionally, the embedded device emulator 142 can be configured to autonomously manage devices connected to the multi-device host controller 141. For example, the embedded device emulator 142 can update and use autonomous device management information 216 to support autonomous device management without the intervention of software. In one example, the autonomous device management information 216 can be stored in any suitable storage that is accessible to the embedded device emulator 142 and/or multi-device host controller 141. Suitable storage can include, but is not limited to, one or more registers, memory (e.g., main memory, read-only memory, etc.), cache, or secondary storage. The autonomous device management information may be standardized through a Host Controller Interface (HCI) Specification. In one or more examples, the autonomous device management information 216 can include a capability indicator (e.g., by a bit in a register, etc.) that indicates the capability of the multi-device host controller 141 to manage an embedded device that is directly connected to the multi-device host controller 141. In some scenarios, a distinct capability indicator may be used for each embedded device connected to the multi-device host controller 141. In other scenarios, a single capability indicator may be used for all embedded devices connected to the multi-device host controller 141.

The autonomous device management information can include other Quality of Service (QoS) information that indicates the types of devices and the number of peripheral devices (e.g., embedded and external devices) that the multi-device host controller 141 can autonomously manage. The autonomous device management information could also indicate other capabilities of the peripheral devices such as support for bandwidth management, support for traffic prioritization among peripheral devices, and/or support for autonomous device management in different low-power states of the USB subsystem 140.

In one or more examples, the embedded device emulator 142 further includes autonomous device management logic 214, which may be implemented as firmware, software, hardware, or any suitable combination thereof. Having multiple peripheral devices connected to the multi-device host controller 141 enables the multi-device host controller 141 to take actions (e.g., via the autonomous device management logic 214) to control the operations, environment, communications, and/or other characteristics or features associated with the connected peripheral devices. At least some of the actions taken are based on inputs (e.g., data and/or signals, etc.) received by the multi-device host controller 141 from other emulated peripheral devices. For example, if thermal sensors are connected to an I3C bus connected to the multi-device host controller 141, then the multi-device host controller may take an action to trigger an embedded controller to turn up the fan or throttle the data transfer to other devices connected to the multi-device host controller 141. The embedded controller may be located outside the multi-device host controller 141 on (or communicatively coupled to) the computing platform 102, and may be configured to manage fans, battery, charging, some voltage rails on the platform, etc. Thus, autonomous management may include taking actions to trigger the embedded controller to add, remove, update, change, or adjust any of the settings or configurations of features under the control of the embedded controller based on inputs (e.g., data and/or signals, etc.) from one or more emulated embedded devices.

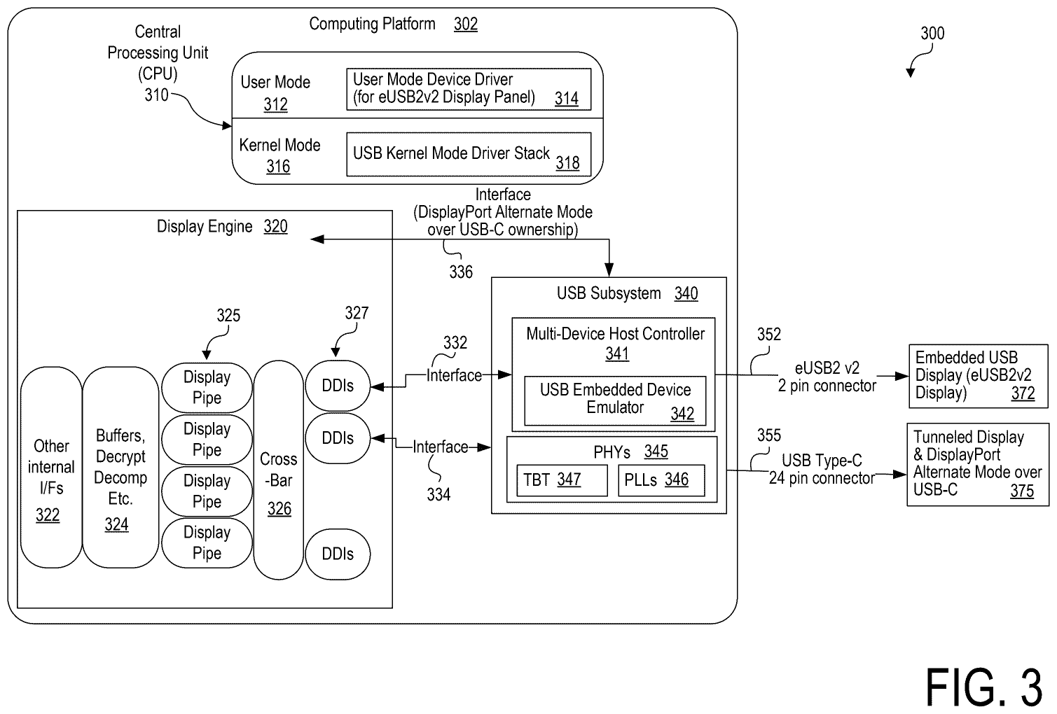

FIG. 3 is a block diagram illustrating a computing system 300 providing a multi-device host controller 341 connected to an embedded USB display 372 operating on an eUSB2 v2 interconnect according to at least one embodiment. In the example shown in FIG. 3, display data could be streamed over an eUSB2v2 link in a scenario where the Panel Self Refresh is not supported in the eUSB2v2 display panel and/or a scenario where the Panel Self Refresh is supported (e.g., with single frame buffer) in the eUSB2v2 display panel. Computing system 300 includes components that may be similar to components shown for computing system 100 of FIG. 1, but for example purposes only, the computing system 300 is illustrated with a configuration to accommodate only an embedded USB display 372 and a tunneled display and display port alternate mode over USB-C 375.

In FIG. 3, a computing platform 302, a CPU 310, and a display engine 320 may be similar to computing platform 102, CPU 110, and display engine 120 of FIG. 1. A kernel mode 316 and a USB kernel mode driver stack 318 of FIG. 3 may be similar to the kernel mode 116 and the USB kernel mode driver stack 118 of FIG. 1. In FIG. 3, a display engine 320, other internal interfaces 322, buffers, decryption, and decompression components 324, display pipes 325, a cross-bar 326, and digital display interfaces (DDIs) 327 may be similar to the display engine 120, other internal interfaces 122, buffers, decryption, and decompression components 124, display pipes 125, a cross-bar 126, and DDIs 127 of FIG. 1. A USB subsystem 340 with a host controller 341 and physical layer (PHY) 345 may be similar to USB subsystem 140 with the multi-device host controller 141 and physical layer 145. For example purposes only, the USB subsystem 340 is illustrated with a configuration to accommodate only embedded USB display 372 and tunneled display and display port alternate mode over USB-C 375. USB subsystem 340 includes a physical layer 345 with PLLs 346 and TBT 347, which are similar to the PLLs 146 and TBT 147 of FIG. 1. Although not shown in FIG. 3, it should be appreciated that the computing system 300 could be further configured to also accommodate additional USB devices and/or other devices using a non-USB protocol (e.g., I3C, SPI, GPIO, etc.).

In one or more examples, the embedded USB display 372 can be physically connected to the host controller 341 via an eUSB2v2 two-pin connector 352. An interface (e.g., PIPE) 332 is provided between the display engine 320 and the USB host controller 341. The interface 332 enables the display engine 120 to provide the display data to the host controller 341, such that typical PHY (e.g., 165, 168) and interfaces (e.g., 162) needed for an embedded display implementation can be omitted or unused. Thus, display data is transmitted from the display engine 320 to the embedded USB display 372 via the new interface 332, the host controller 341, and the eUSB2v2 two-pin connector 352. In at least some scenarios, the interface couples the host controller 341 to one or more DDIs 327 of the display engine 320. The interface 332 between the display engine 320 and the multi-device host controller 341 may be any suitable logical connection (or any other suitable communicative coupling) including, but not necessarily limited to a Physical Interface for the PCI Express and USB SuperSpeed Architectures (PIPE).

The host controller 341 includes an embedded USB embedded device emulator 342, which can be configured as logic (e.g., firmware, software, hardware, or any suitable combination thereof) to emulate a USB device controller of the embedded USB display 372. The USB embedded device emulator 342 may include structure and logic that is the same or similar to the structure and logic shown and described with reference to the embedded device emulator 142 of FIGS. 1 and 2.

The USB embedded device emulator 342 presents the embedded USB display 372 to system software (e.g., USB kernel mode driver stack 318) without requiring interactions with a physical USB display device controller. Because the USB embedded device emulator 342 is configured for the embedded USB display 372, which is known a priori to the computing system's integration, the host controller 341 can be pre-programmed to correctly represent the capabilities of the embedded USB display 372. Pre-programming the host controller 341 can be performed by the basic input/output system (BIOS) or another sideband mechanism at the system integration stage. Once pre-programmed with the appropriate information for the embedded USB display 372, the USB embedded device emulator 342 can provide the capabilities of the connected embedded USB display 372 and present a hot plug event (e.g., notification to software that something has changed in the system's configuration) to system software to indicate the presence of a new USB device. The USB embedded device emulator 342 can also respond to standard USB control transfers with a standard set of USB descriptors to describe a typical USB device without requesting any information from the embedded USB display 372. Thus, typical enumeration communications between an embedded USB display (e.g., 372) and a USB host controller may be omitted, which can increase efficiency gains in signal processing and power consumption for the computing system 300.

Optionally, the USB embedded device emulator 342 may be configured to allow downstream communications for configuration changes to the embedded USB display 372. For example, although the resolution of the embedded USB display 372 can be pre-configured at a particular resolution at a particular pixel clock, a user may be allowed to change the configuration. In this case, the USB embedded device emulator 342 may communicate with the embedded USB display 372 over the eUSB2v2 connector 352 to provide configuration information to appropriately configure the particular capability or capabilities of the embedded USB display 372.

Because the USB embedded device emulator 342 emulates the embedded USB display 372, the eUSB2v2 physical layer at the appropriate downstream port of the multi-device host controller 341 could be limited to transmit activities only. Additionally, the eUSB2v2 physical layer and USB device controller can be updated for a bare minimal receiver-only implementation. Thus, the capabilities of embedded USB display 372 can be simplified to receiving display data, but not sending data or responding to requests for data. Optionally, the capabilities of the embedded USB display 372 may allow receiving configuration information (e.g., from the USB embedded device emulator 342) to configure the embedded USB display 372.

Optionally, a tunneled display and display port 375 may also be connected to USB subsystem 140 over a USB type-C connector 355, which may include 24 pins in one example. The tunneled display and display port 375 may receive display data from the display engine 320 via an interface 334 (e.g., PIPE), and the USB subsystem physical layer. The physical layer 345 may include Thunderbolt (TBT) 347 to provide the display data to the tunneled display 375 as a tunneled display over the USB type-C connector 355. Another interface 336 (e.g., display port alternate mode over USBC-C ownership) may also allow communication between the USB subsystem 340 and the display engine 320 to provide display data to the display 375 as DisplayPort Alternate Mode over USB-C connector.

The USB software stack that runs on CPU 310 facilitates communication between applications and the multi-device host controller 341. The USB software stack includes some of the standard USB software for the embedded USB devices. For example, USB kernel mode driver stack 318 can include standard system software for USB that runs in kernel mode 316 on CPU 310. A user mode device driver 314 can also include standard user-mode software for embedded USB display 372 that runs in a user mode 312 on the CPU 310 and that communicates with a multi-device host controller 341. User mode device driver 314 in the USB software stack can include USB class-based drivers for communications with the embedded USB display 372. The existing USB class-based drivers for embedded USB display 372 can be leveraged for communications from the CPU 310 to the embedded USB display 372 (and any other embedded USB devices such as tunneled display and display port 375) via the multi-device host controller 341.

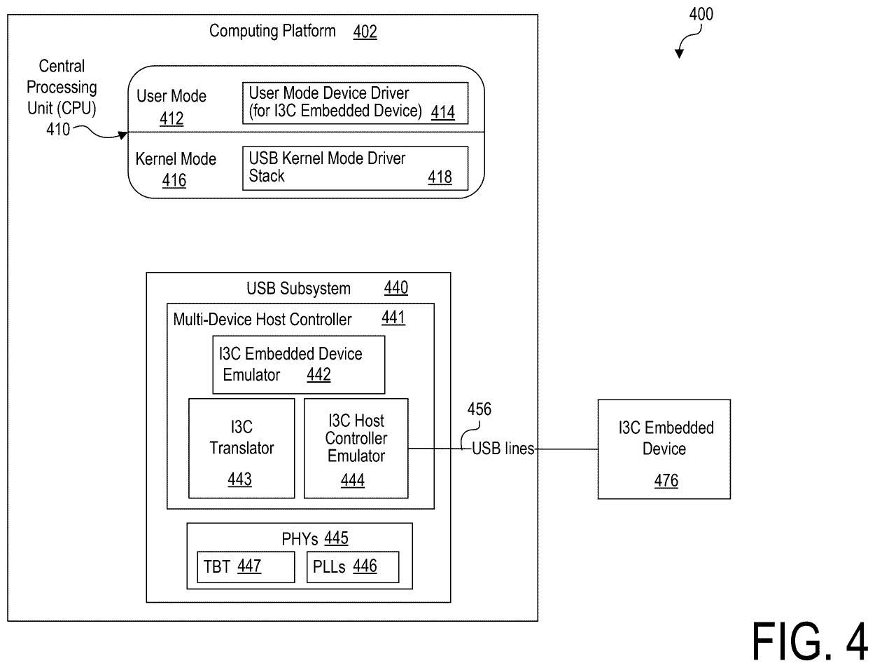

FIG. 4 is a block diagram illustrating a computing system 400 providing a multi-device host controller 441 connected to an improved inter integrated circuit (I3C device) via an I3C bus according to at least one embodiment. Computing system 400 includes components that may be similar to components shown in computing system 100 of FIG. 1, but for example purposes only, the computing system 400 is illustrated with a configuration to accommodate only an I3C device 476.

In FIG. 4, a computing platform 402 and a CPU 410 may be similar to computing platform 102 and CPU 110 of FIG. 1. A kernel mode 416 and a USB kernel mode driver stack 418 of FIG. 4 may be similar to the kernel mode 116 and the USB kernel mode driver stack 118 of FIG. 1. A USB subsystem 440 with a host controller 441 and physical layer (PHY) 445 may be similar to USB subsystem 140 with the multi-device host controller 141 and physical layer 145. For example purposes only, the USB subsystem 440 is illustrated with a configuration to accommodate only the I3C embedded device 476. USB subsystem 440 includes a physical layer 445 with PLLs 446 and TBT 447, which are similar to the PLLs 146 and TBT 147 of FIG. 1. Although not shown in FIG. 4, it should be appreciated that the computing system 400 of FIG. 4 could also include a display engine (e.g., display engines 120, 320) and embedded display(s) (e.g., embedded USB displays 172, 372, and tunneled display and display port alternate mode over USB-C 375), and/or other USB devices (e.g., embedded camera 174), along with appropriate interfaces (e.g., 162, 164, 362, 364), connectors (e.g., 152, 154, 352, 355) and USB embedded device emulators (e.g., 142, 342) for USB embedded devices.

In one or more examples, the I3C device 476 can be physically connected to the host controller 441 by USB lines 456 (e.g., USB type-C or any other suitable USB connection) over which I3C data can be transmitted and/or received by the I3C device 476. In at least one example, USB lines 456 can be implemented as a 2-pin connector (e.g., D+ and D−) and transmit I3C in one direction at a given time. In at least some examples, suitable electronic components may be utilized to facilitate coupling the USB lines 456 to host controller 441. For example, one or more multiplexers may be used to communicate to the multi-device host controller 441 a particular communication has been received from a device using the I3C protocol.

The multi-device host controller 441 includes an I3C host controller emulator 444 that can be configured as logic (e.g., firmware, software, hardware, or any suitable combination thereof) in host controller 441 to emulate an I3C host controller (e.g., 163) that has been omitted form computing system 400. In some examples, the I3C host controller emulator 444 may include distinct controller logic for each embedded I3C device, such as I3C device 476, in computing system 400. In other examples, the same controller logic may be utilized for two or more embedded I3C devices in computing system 400.

The host controller 441 also includes an I3C embedded device emulator 442, which can be configured as logic (e.g., firmware, software, hardware, or any suitable combination thereof) to emulate an I3C device controller of the I3C device 476 and possibly other embedded I3C devices (not shown in FIG. 4) of computing system 400. The I3C embedded device emulator 442 may include structure and logic that is the same or similar to the structure and logic shown and described with reference to the embedded device emulator 142 of FIGS. 1 and 2.

The I3C embedded device emulator 442 presents the I3C device 476 as a USB device to system software (e.g., USB kernel mode driver stack 418) without requiring interactions with a physical I3C device controller of the I3C device 476. Because the I3C embedded device emulator 442 is configured for the I3C device 476, which is known a priori to the computing system's integration, the host controller 441 can be pre-programmed to correctly represent the capabilities of the I3C device 476. Pre-programming the host controller 441 can be performed by the basic input/output system (BIOS) or another sideband mechanism at the system integration stage. Once pre-programmed with the appropriate information for the I3C device 476, the I3C embedded device emulator 442 can provide the capabilities of the connected embedded I3C device 476 and present a hot plug event (e.g., notification to software that something has changed in the system's configuration) to system software to indicate the presence of a new USB device, even though the device is the I3C device 476, rather than a USB device. The I3C embedded device emulator 442 can also respond to standard USB control transfers to the I3C device 476 with a standard set of USB descriptors to describe the I3C embedded device using a format and information expected for a USB device without requesting any information from the I3C device. Thus, typical configuration communications between the I3C embedded device (e.g., 476) and a physical I3C host controller (e.g., 163) may be omitted, which can result in efficiency gains in signal processing and power consumption for the computing system 400.

Optionally, the I3C embedded device emulator 442 may be configured to allow downstream communications for configuration changes to the embedded I3C device 476, if the embedded I3C device 476 allows configuration changes. In this case, the I3C embedded device emulator 442 may communicate with the I3C device 476 over the USB lines 456 to provide configuration information to appropriately configure the particular capability or capabilities of the I3C device 476.

Because the I3C embedded device emulator 442 emulates the I3C device 476, if the I3C device 476 is primarily designed to receive data from the CPU 410 and the I3C device 476 can perform its intended function without sending data to the CPU 410, then the USB physical layer at the appropriate downstream port of the multi-device host controller 441 could be limited to transmit activities only. Additionally, the I3C physical layer and I3C device controller of the I3C device 476 can be updated for a bare minimal receiver-only implementation. Thus, the capabilities of the I3C device 476 can be simplified to receiving data, but not sending data or responding to requests for data. Optionally, the capabilities of the I3C device 476 may allow receiving configuration information (e.g., from the I3C embedded device emulator 442) to configure the I3C device.

In one or more examples, the host controller 441 is configured with an I3C translator 443 for embedded I3C devices, such as I3C device 476, that operate using the I3C protocol. An I3C translator 443 can be configured as logic (e.g., firmware, software, hardware, or any suitable combination thereof) in host controller 441 to convert USB requests to I3C transactions or messages.

The USB subsystem 440 includes a physical layer 445 that can include phase-locked loops (PLLs) 446 for clock generation, frequency synthesis, data recovery, etc. The physical layer 445 may also include Thunderbolt (TBT) 447, which is a hardware interface allowing the connection of external peripheral devices using PCI Express (PCIe) and Display Port (DP) to transmit data and video signals in a tunneled display over the same cable (e.g., USB type-C 24-pin connector).

A USB software stack that runs on CPU 410 facilitates communication between applications and the multi-device host controller 441. The USB software stack includes some of the standard USB software for USB devices. For example, USB kernel mode driver stack 418 can include standard system software for USB that runs in kernel mode 416 on CPU 410. The USB kernel mode software stack 418 can be used by I3C device 476 and other I3C devices that communicate with I3C controller emulator 444. User mode software in the USB software stack includes a user mode I3C device driver 414 that runs in a user mode 412 on CPU 410. The user mode I3C device driver 414 can be configured on top of the USB software stack for the I3C device 476. Because data is received at the CPU 410 from the embedded I3C device 476 according to the USB protocol, the user mode I3C device driver 414 is configured to understand that the received USB data is associated with an I3C device, and to appropriately consume and digest the received USB data from the I3C device 476. In some scenarios, the received USB data may be translated back to I3C data in accordance with the I3C communication protocol, which is associated with the I3C device 476. Conversely, for I3C devices that receive data from the CPU 410, I3C data generated by the CPU 410 for the I3C device 476, may be translated by the user mode device driver 414 (or by other software in the user mode software stack) to USB data in accordance with the appropriate USB protocol.

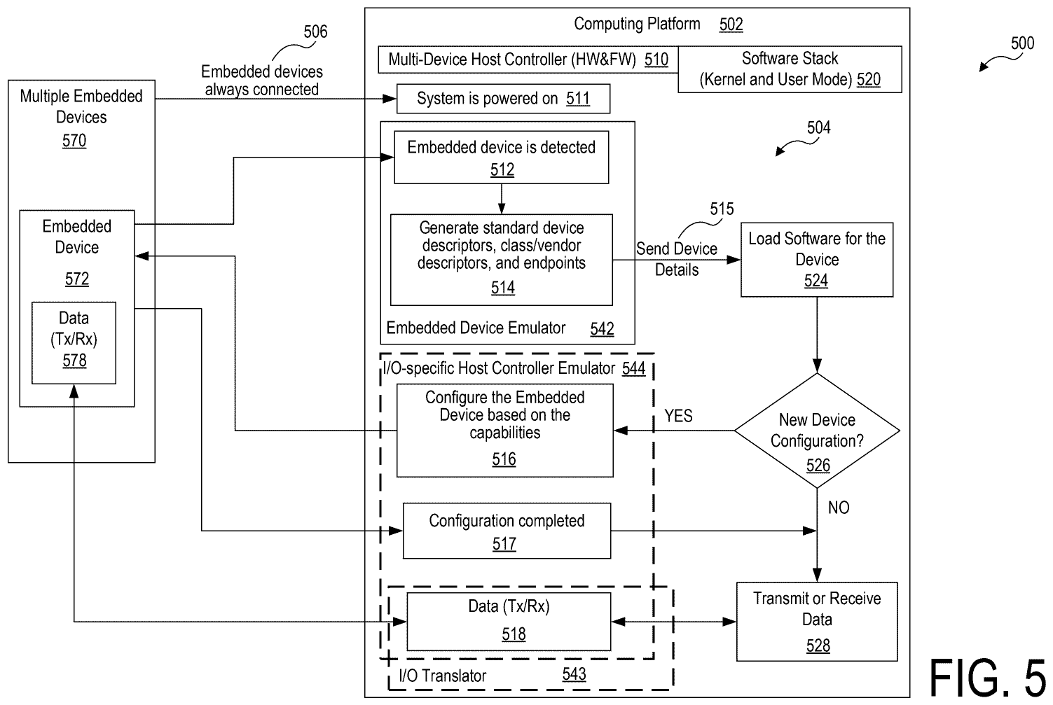

FIG. 5 is a block diagram of a computing system 500 and a flow diagram 504 illustrating possible operations of a computing platform 502 in computing system 500, according to at least one embodiment. In one example, the computing platform 502 may be similar to other computing platforms (e.g., computing platforms 102, 302, 402) disclosed herein. Generally, computing platform 502 comprises a multi-device host controller 510 and a software stack 520, which may be similar to multi-device host controllers 141, 341, 441 and USB software stacks 114/118, 314/318, 414/418. The multi-device host controller 510 includes an embedded device emulator 542, which may be similar to other embedded device emulators 142, 342, 442 disclosed herein. If the computing system 500 includes non-USB I/O devices, then the multi-device host controller 510 further includes an I/O-specific host controller emulator 544 (e.g., which may be similar to other I/O-specific host controller emulators 144, 444), and an I/O-specific translator 543 (e.g., which may be similar to other I/O-specific translators 143, 443).

The computing system 500 also includes multiple embedded devices 570 including one or more embedded devices (e.g., 172, 174, 372, and/or others) and one or more non-USB embedded devices (e.g., 176, 178, 476, and/or others), which are communicatively coupled to the multi-device host controller 510 of the computing platform 502. For illustrative purposes, one embedded device 572, which could be a USB device or a non-USB device, is referenced herein to describe possible communications, operations, and components shown in FIG. 5. As shown at 506, the multiple embedded devices 570, including the embedded device 572, are always communicatively connected to the computing platform 502.

The operations of flow diagram 504 begin at 511, where the computing system is powered on. The operations include enumeration (e.g., detecting, identifying, loading appropriate drivers) and optionally, configuration of an embedded device. The enumeration and optional configuration operations may be repeated, sequentially or at least partly in parallel, for each embedded device that is detected.

At 512, the multi-device host controller detects an embedded device of the multiple embedded devices 570 that are directly connected (e.g., by wires, pins, and/or other suitable conductive material) to the multi-device host controller 510. In one example, embedded device 572 is detected at 512 by trigger logic (e.g., 212) based on device-specific I/O signaling from the embedded device 572 (e.g., an eUSB2v2 device pulling the eD+ or eD− data line high through a 1.5 kΩ resistor, an I3C device sending a special interrupt request with a reserved I3C address, an I2C device pulling the SDA line low, etc.). In one example, the trigger logic 212 can start the embedded device emulator 542, which establishes an entry point to begin emulator operations for the embedded device.

At 514, the embedded device emulator 542 generates standard device descriptors (e.g., device, configuration, interface, endpoint, and companion descriptors), class/vendor specific descriptors, and endpoints (e.g., bulk, isoch, and interrupt endpoints) for embedded device 572. The descriptors and endpoints can be generated based on peripheral configuration information (e.g., 210), which is pre-programmed in the multi-device host controller 510 during the design phase or system integration of the computing system 500. It should be noted that, in current implementations of USB and eUSB2v2, these descriptors are requested from the USB embedded device by the USB multi-device host controller. In the flow diagram 504, however, the descriptors are generated for USB devices (including eUSB2v2 devices) and other I/O devices (e.g., I3C, I2C, SPI, GPIO, etc.) without the multi-device host controller 510 sending requests to the embedded device for USB descriptors or information similar to USB descriptors, and without the multi-device host controller 510 receiving communications from the embedded device containing USB descriptors or information similar to USB descriptors.

At 524, a software stack 520 is loaded by a CPU (e.g., CPUs 110, 310, 410). The software stack 520 can include both a kernel mode driver stack and a user mode driver stack. For a USB embedded device, a standard USB user mode device driver for the particular type of USB device (e.g., user mode device driver 314 for embedded USB display 372) can be loaded to run in the user mode (e.g., user modes 112, 312, 412) of the CPU (e.g., CPUs 110, 310, 410). For non-USB embedded devices, an I/O-specific user mode device driver (e.g., I3C user mode device driver 414 for I3C embedded device 476) can be loaded to run in the user mode of the CPU. Additionally, a USB kernel mode driver stack (e.g., USB kernel mode driver stack 118, 318, 418) can be loaded to run in the kernel mode (e.g., kernel modes 116, 316, 416) of the CPU (e.g., CPUs 110, 310, 410) for both USB devices and non-USB devices.

At 515, the device details of the embedded device 572, as provided in the generated descriptors, are sent to the loaded software stack 520 for the embedded device 572.

Optionally, at 526, the user mode device driver determines whether a new configuration for the embedded device 572 is requested (e.g., by user input to an application that accesses the embedded device 572) or otherwise needed (e.g., software update to user mode device driver to change default setting, an application that communicates with the embedded device requires a different configuration, etc.). Subsequent to sending the USB descriptors to the software stack 520, if no new device configuration is requested or otherwise needed for embedded device 572, then at 528, communications in the form of data transmissions between the embedded device 572 and the CPU (e.g., CPUs 110, 310, 410) or applications running on the CPU can be facilitated via the software stack 520 and the multi-device host controller 510.

If a determination is made at 526 that a new device configuration is requested or otherwise needed for embedded device 572, then the software stack communicates information indicating the new device configuration to the multi-device host controller 510. At 516, the multi-device host controller 510 configures the embedded device 572 based on the embedded device's capabilities.

For at least some USB embedded devices, the existing capabilities of a USB host controller that are included in multi-device host controller 510 can perform configuration changes to USB embedded devices. For example, if the embedded device 572 is an embedded USB display (e.g., 172, 372), USB descriptors generated by the embedded device emulator 542 can include a resolution setting for the embedded USB display. If a user requests a different resolution setting, then the multi-device host controller 510 can change the resolution setting on the embedded device 572 to correspond to the resolution setting requested by the user.

For non-USB embedded devices, however, an I/O-specific host controller emulator 544 in the multi-device host controller 510 can optionally be configured to perform configuration changes to the corresponding I/O embedded device. For example, if the embedded device 572 is an I3C temperature sensor, USB descriptors generated by the embedded device emulator 542 could include a data rate setting for the I3C sensor to send updated temperature readings according to the data rate. If an application requires temperature readings at a different rate, then the I/O-specific host controller emulator 544 (e.g., for I3C temperature sensors) can change the data rate setting on the embedded device 572 to correspond to the data rate setting required by the application.

At 517, the multi-device host controller 510 receives a signal from the embedded device 572 indicating that the configuration change was completed. Once the configuration of the embedded device 572 has been completed, at 528, communications in the form of data transmissions between the embedded device 572 and the CPU (e.g., CPUs 110, 310, 410) or applications running on the CPU can be facilitated via the software stack 520 and the multi-device host controller 510. Depending on the functionality of the embedded device 572, data transmissions could be unidirectional or bidirectional. More specifically, the functionality of the embedded device 572 could allow (1) data to be sent by the embedded device 572 to the CPU (or an application running on the CPU) via the multi-device host controller 510 and the software stack 520, (2) data to be received by the embedded device 572 from the CPU (or an application running on the CPU) via the software stack 520 and the multi-device host controller 510, or (3) data to be sent by the embedded device 572 and data to be received by the embedded device 572. Possible data transmissions are indicated by a first transmission path from data 578 transmitted from the embedded device 572 to data 518 received in the multi-device host controller 510 to data received at 528 in the software stack 520 (e.g., to be provided to the CPU or an application running on the CPU). A second possible transmission path is indicated at 528 where data is transmitted from the software stack 520 (e.g., received from the CPU or an application running on the CPU) to data 518 received in the multi-device host controller 510 to data 578 received in the embedded device 572.

For at least some USB embedded devices, the existing capabilities of a USB host controller that are included in multi-device host controller 510 can facilitate data communications between the (USB) embedded device 572 and the software stack 520. In one example, if data 518 is received from the (USB) embedded device 572, then the data 518 is forwarded to the software stack 520. If data 518 is received from the software stack 520, however, then the data 518 is forwarded to the (USB) embedded device 572.

For non-USB embedded devices, however, the I/O-specific host controller emulator 544 in the multi-device host controller 510 can be configured to facilitate data communications between the (non-USB) embedded device 572 and the software stack 520. In addition, an I/O-specific translator 543 may be provided to translate data received based on the specific I/O protocol of the embedded device 572. For example, if the embedded device 572 is an I3C embedded device, then the I/O-specific translator 543 may translate I3C data received from the I3C embedded device 572 to USB data before sending to the software stack 520. In reverse, the I/O-specific translator 543 may translate USB data received from the software stack 520 to I3C data before sending to the I3C embedded device 572.

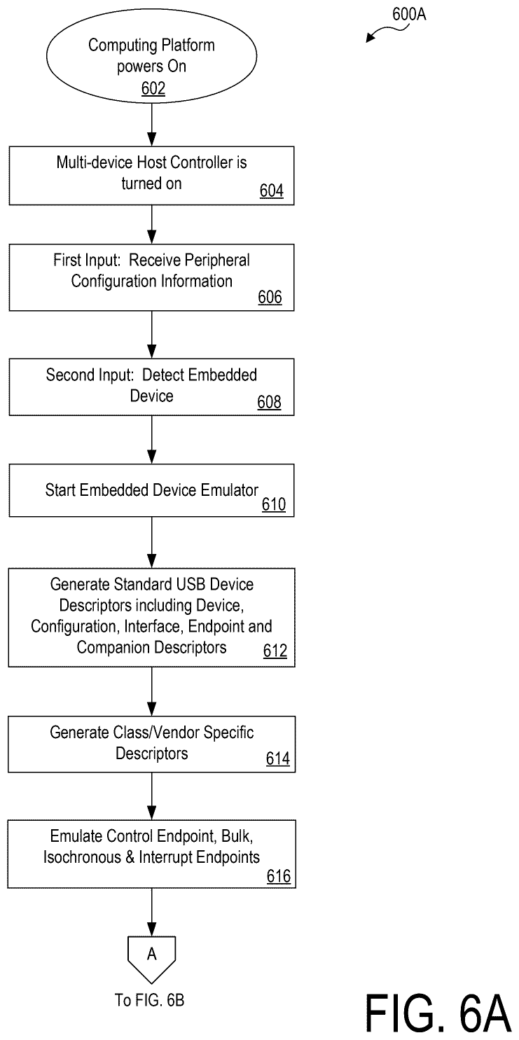

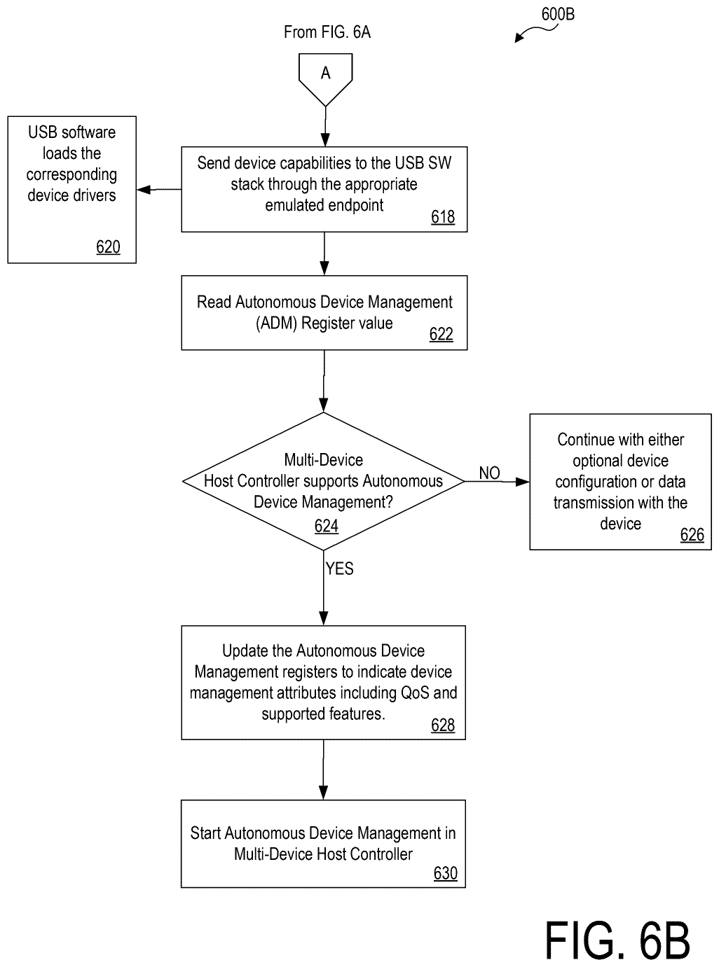

FIGS. 6A and 6B are simplified flow diagrams 600A and 600B of an example process that may be performed according to at least one embodiment. A computing system (e.g., computing system 100, 300, 400, 500) may comprise means such as a computing platform (e.g., computing platforms 102, 302, 402, 502), one or more processors (e.g., CPUs 110, 310, 410), a multi-device host controller (e.g., multi-device host controllers 141, 341, 441, 510), and an embedded device (e.g., embedded devices 170, 372, 476, 570) for performing the operations. In one example, at least some operations shown in flow diagrams 600A and 600B may be performed by an embedded device emulator (e.g., embedded device emulators 142, 342, 442, 542), an I/O-specific host controller emulator (e.g., I/O-specific host controller emulators 144, 444, 544), and/or an I/O-specific translator (e.g., I/O-specific translators 143, 443, 543) of the multi-device host controller. For ease of illustration, FIGS. 6A-6B will be described with reference to components shown in FIGS. 1-2. It should be appreciated, however, that the flow diagrams 600A-600B are also applicable to other computing systems shown herein (e.g., computing systems 300, 400, 500, and 800 in FIGS. 3, 4, 5, and 8).

At 602, computing platform 102 of the computing system 100 is turned on. Multiple embedded devices 170 are always connected to the computing platform 102 and may receive power when the computing platform 102 is powered on. At 604, the multi-device host controller 141 in the USB subsystem 140 is turned on.

The multi-device host controller 141 can receive various inputs when the controller is turned on. At 606, a first input is received. The first input is peripheral configuration information, which is used to pre-program the multi-device host controller 141 with the capabilities supported by each of the embedded devices 170 that is communicatively connected to the multi-device host controller 141 and that is to be emulated by the multi-device host controller 141. The peripheral configuration information may be stored in fuses or a configuration file of the computing system 100 and can be received by the multi-device host controller 141 from BIOS or any other suitable sideband mechanism.

At 608, a second input is received by the multi-device host controller 141. The second input is a signal from an embedded device that enables detection by trigger logic 212 of the multi-device host controller 141. Trigger logic 212 can detect an embedded device based on I/O signaling that is specific to that embedded device, which may be defined in the standard IO specification and/or a manufacturer's specification for that embedded device. The detected embedded device could be any of the multiple embedded devices 170 including a USB embedded device (e.g., 172 or 174) or a non-USB embedded device (e.g., 176 or 178).

At 610, the embedded device emulator 142 can be started to emulate the detected embedded device. At 612, the embedded device emulator 142 can generate standard USB device descriptors, which may include device descriptors, configuration descriptors, interface descriptors, endpoint descriptors, and companion descriptors for the embedded device detected at 608. At 614, the embedded device emulator 142 generates class-specific descriptors and/or vendor-specific descriptors, if any, for the detected embedded device detected at 608. At 616, the embedded device emulator 142 can generate endpoints (e.g., control, bulk, isoch, and interrupt endpoints) for the embedded device detected at 608. It should be noted that the USB descriptors and endpoints are generated for both USB embedded devices and non-USB (e.g., I3C, SPI, GPIO, etc.) embedded devices.

With reference to flow diagram 600B in FIG. 6B, at 618, the device capabilities of the embedded device detected at 608, are sent to the USB software stack through the appropriate emulated endpoint. The USB software stack can include the kernel mode driver stack 118 and the I/O-specific user mode device driver 114 for the embedded device detected at 608. At 620, the USB software, such as a USB host controller driver and a USB bus driver, loads the corresponding device drivers (e.g., for embedded devices detected by the multi-device host controller 141). The loaded device drivers for embedded devices connected to the multi-host controller sit on top of the USB software stack and are be bound to their respective embedded devices.

At 622, the embedded device emulator 142 reads an autonomous device management (ADM) value in the autonomous device management information 216. The autonomous device management information may be stored in any suitable storage including, but not limited to one or more registers, memory, or other storage. At 624, a determination is made as to whether the multi-device host controller 141 supports autonomous device management, based on a capability indicator (e.g., a value or bit) read from autonomous device management information 216, which may be stored in a register, memory, or other suitable storage. If a determination is made at 624 that the multi-device host controller 141 does not support ADM, then at 626, the process continues with optional embedded device configuration (e.g., 516 and 517) or with data transmission between the embedded device detected at 608 and the CPU 110 or an application running on the CPU. The data transmission is facilitated by the multi-device host controller 141 and the USB software stack (e.g., 118 and 114).

If a determination is made at 624 that the multi-device host controller 141 does support ADM, then at 628, the autonomous device management information 216 may be updated to indicate device management attributes including quality of service (Qos) and supported features of the embedded device. QoS fields in the one or more ADM registers can indicate the types of peripheral devices and the number of peripheral devices (e.g., embedded and external devices) that the multi-device host controller 141 can autonomously manage. Other information in the autonomous device management information 216 could be used to indicate other capabilities of the peripheral devices such as support for bandwidth management, support for traffic prioritization among peripheral devices, and/or support for autonomous device management in different low-power states of the USB subsystem 140.

At 630, autonomous device management can be started to enable the multi-device host controller 141 to take one or more actions to control or otherwise manage the operations, environment, communications, and/or other characteristics or features associated with the connected and emulated embedded devices that can be autonomously managed (e.g., as indicated in the autonomous device management information). The embedded device emulator 142 can autonomously manage the embedded devices 170 connected to the multi-device host controller 141 based on one or more inputs (e.g., data and/or signals) of one or more other emulated embedded devices. In one example, the multi-device host controller 141 can, based at least in part on the input(s) from other emulated embedded device(s), take actions to cause settings and/or configurations of an embedded device, or of another device (e.g., embedded controller), or of features under the control of the embedded device or another device, to be added, removed, updated, changed, or adjusted. Also, it should be noted that, optionally, if a configuration change request is received from the software stack, then an embedded device configuration change (e.g., 516 and 517) may be performed via the multi-device host controller 141 (e.g., by embedded device emulator 142).

Examples provided herein have described a multi-device host controller within a USB subsystem of a computing system, and the multi-device host controller emulates both USB embedded devices and non-USB embedded devices to generate USB descriptors for each of the embedded devices (both USB and non-USB embedded devices). It should be noted however, that the emulation concepts described herein are also applicable to other communication protocols. Accordingly, the multi-device host controller could be configured to generate, for example, appropriate device information based on a particular non-USB protocol for each of the connected embedded devices (both USB and non-USB embedded devices). The software stack could be appropriately configured to communicate to the multi-device host controller based on the particular non-USB protocol.

It should also be noted that, although the concepts herein are particularly useful for embedded peripheral devices, one or more of the concepts may also be applicable for peripheral devices that are not embedded. For example, peripheral configuration information for an external peripheral device could be provided to the multi-device host controller out-of-band, thus enabling the multi-device host controller to emulate the external peripheral device. In another example, autonomous device management for at least some features may be performed for external peripheral devices based on the inputs of the embedded devices or potentially inputs of other external peripheral devices.

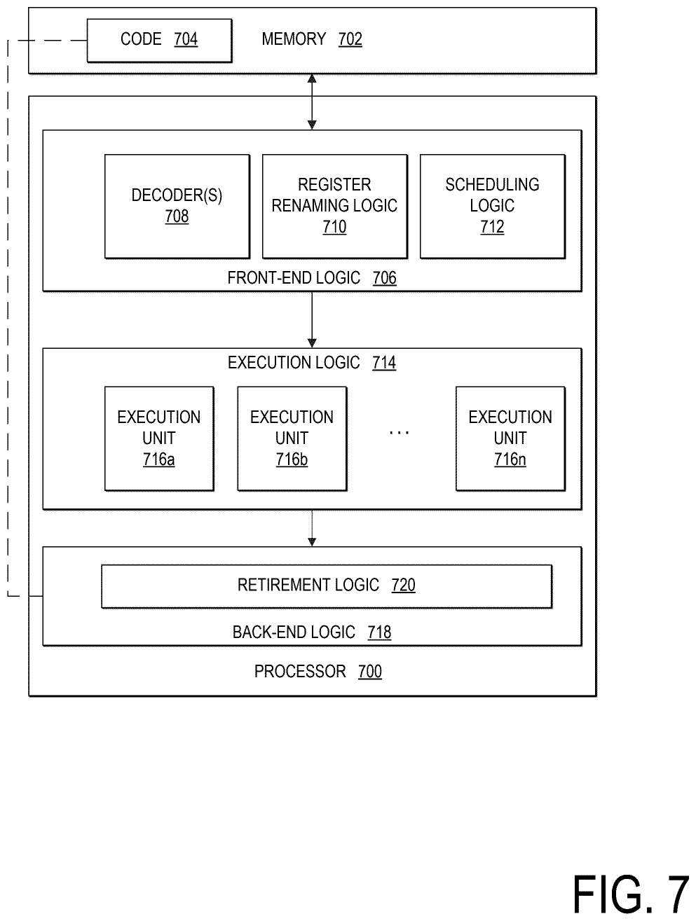

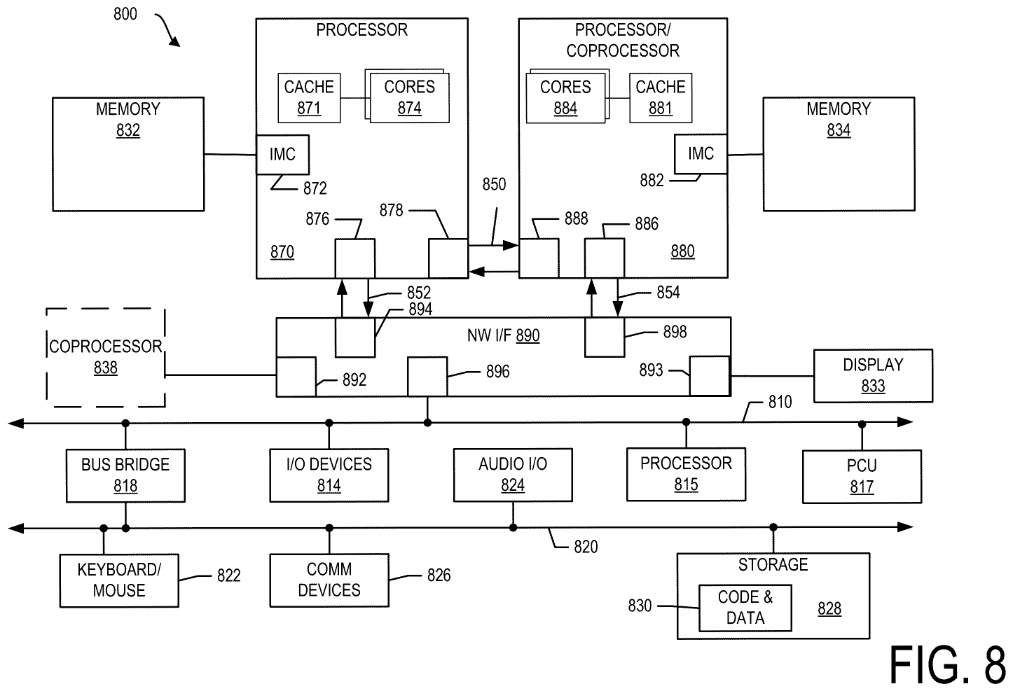

FIGS. 7-8 are block diagrams of exemplary computer architectures that may be used in accordance with embodiments disclosed herein. Other computer architecture designs known in the art for processors and computing systems may also be used. Generally, suitable computer architectures for embodiments disclosed herein can include, but are not limited to, configurations illustrated in FIGS. 7-8.

FIG. 7 is an example illustration of a processor according to an embodiment. Processor 700 is an example of a type of hardware device that can be used in connection with the implementations above. For example, processor 700 provides one example implementation of CPUs 110, 310, 410. Processor 700 may be any type of processor, such as a microprocessor, an embedded processor, a digital signal processor (DSP), a network processor, a multi-core processor, a single core processor, or other device to execute code. Although only one processor 700 is illustrated in FIG. 7, a processing element may alternatively include more than one of processor 700 illustrated in FIG. 7. Processor 700 may be a single-threaded core or, for at least one embodiment, the processor 700 may be multi-threaded in that it may include more than one hardware thread context (or “logical processor”) per core.

FIG. 7 also illustrates a memory 702 coupled to processor 700 in accordance with an embodiment. Memory 702 may be any of a wide variety of memories (including various layers of memory hierarchy) as are known or otherwise available to those of skill in the art. Such memory elements can include, but are not limited to, random access memory (RAM), read only memory (ROM), logic blocks of a field programmable gate array (FPGA), erasable programmable read only memory (EPROM), and electrically erasable programmable ROM (EEPROM).

Processor 700 can execute any type of instructions associated with algorithms, processes, or operations detailed herein. Generally, processor 700 can transform an element or an article (e.g., data) from one state or thing to another state or thing.

Code 704, which may be one or more instructions to be executed by processor 700, may be stored in memory 702, or may be stored in software, hardware, firmware, or any suitable combination thereof, or in any other internal or external component, device, element, or object where appropriate and based on particular needs. In one example, processor 700 can follow a program sequence of instructions indicated by code 704. Each instruction enters a front-end logic 706 and is processed by one or more decoders 708. The decoder may generate, as its output, a micro operation such as a fixed width micro operation in a predefined format, or may generate other instructions, microinstructions, or control signals that reflect the original code instruction. Front-end logic 706 also includes register renaming logic 710 and scheduling logic 712, which generally allocate resources and queue the operation corresponding to the instruction for execution.

Processor 700 can also include execution logic 714 having a set of execution units 716a, 716b, 716n, etc. Some embodiments may include a number of execution units dedicated to specific functions or sets of functions. Other embodiments may include only one execution unit or one execution unit that can perform a particular function. Execution logic 714 performs the operations specified by code instructions.

After completion of execution of the operations specified by the code instructions, back-end logic 718 can retire the instructions of code 704. In one embodiment, processor 700 allows out of order execution but requires in order retirement of instructions. Retirement logic 720 may take a variety of known forms (e.g., re-order buffers or the like). In this manner, processor 700 is transformed during execution of code 704, at least in terms of the output generated by the decoder, hardware registers and tables utilized by register renaming logic 710, and any registers (not shown) modified by execution logic 714.

Although not shown in FIG. 7, a processing element may include other elements on a chip with processor 700. For example, a processing element may include memory control logic along with processor 700. The processing element may include I/O control logic and/or may include I/O control logic integrated with memory control logic. The processing element may also include one or more caches. In some embodiments, non-volatile memory (such as flash memory or fuses) may also be included on the chip with processor 700.

FIG. 8 illustrates an example computing system 800. Generally, one or more of the computing systems described herein (e.g., 100, 300, 400, 500) may be configured in the same or similar manner as computing system 800.

The computing system 800 is a multiprocessor system, which is an interfaced system and includes a plurality of processors or cores including a first processor 870 and a second processor 880 coupled via an interface 850 such as a point-to-point (P-P) interconnect, a fabric, and/or bus. In some examples, the first processor 870 and the second processor 880 are homogeneous. In some examples, first processor 870 and the second processor 880 are heterogenous. Though the example system 800 is shown to have two processors, the system may have three or more processors, or may be a single processor system. In some examples, the computing system is a system on a chip (SoC).

Processors 870 and 880 may be implemented as single core processors or multi-core processors. Processors 870 and 880 may each include a cache 871 and 881 used by their respective core or cores 874, 884. A shared cache (not shown) may be included in either processor or outside of both processors, yet connected with the processors via P-P interconnect, such that either or both processors' local cache information may be stored in the shared cache if a processor is placed into a low power mode.

Processors 870 and 880 are shown including integrated memory controller (IMC) circuitry 872 and 882, respectively. Processor 870 also includes interface circuits 876 and 878; similarly, second processor 880 includes interface circuits 886 and 888. Processors 870, 880 may exchange information via the interface 850 using interface circuits 878, 888. IMCs 872 and 882 couple the processors 870, 880 to respective memories, namely a memory 832 and a memory 834, which may be portions of main memory locally attached to the respective processors.

Processors 870, 880 may each exchange information with a network interface (NW I/F) 890 via individual interfaces 852, 854 using interface circuits 876, 894, 886, 898. The network interface 890 (e.g., one or more of an interconnect, bus, and/or fabric, and in some examples is a chipset) may optionally exchange information with a coprocessor 838 via an interface circuit 892. In some examples, the coprocessor 838 is a special-purpose processor, such as, for example, a high-throughput processor, a network or communication processor, compression engine, graphics processor, general purpose graphics processing unit (GPGPU), neural-network processing unit (NPU), embedded processor, or the like. Network interface 890 may also provide information to a display 833 using an interface circuitry 893, for display to a human user.

A shared cache (not shown) may be included in either processor 870, 880 or outside of both processors, yet connected with the processors via an interface such as P-P interconnect, such that either or both processors' local cache information may be stored in the shared cache if a processor is placed into a low power mode.

Network interface 890 may be coupled to a first interface 810 via interface circuit 896. In some examples, first interface 810 may be an interface such as a Universal Serial Bus (USB), embedded USB 2 version 2 (eUSB2v2), Peripheral Component Interconnect (PCI) interconnect, a PCI Express interconnect or another I/O interconnect. In some examples, first interface 810 is coupled to a power control unit (PCU) 817, which may include circuitry, software, and/or firmware to perform power management operations with regard to the processors 870, 880 and/or co-processor 838. PCU 817 provides control information to a voltage regulator (not shown) to cause the voltage regulator to generate the appropriate regulated voltage. PCU 817 also provides control information to control the operating voltage generated. In various examples, PCU 817 may include a variety of power management logic units (circuitry) to perform hardware-based power management. Such power management may be wholly processor controlled (e.g., by various processor hardware, and which may be triggered by workload and/or power, thermal or other processor constraints) and/or the power management may be performed responsive to external sources (such as a platform or power management source or system software).

PCU 817 is illustrated as being present as logic separate from the processor 870 and/or processor 880. In other cases, PCU 817 may execute on a given one or more of cores (not shown) of processor 870 or 880. In some cases, PCU 817 may be implemented as a microcontroller (dedicated or general-purpose) or other control logic configured to execute its own dedicated power management code, sometimes referred to as P-code. In yet other examples, power management operations to be performed by PCU 817 may be implemented externally to a processor, such as by way of a separate power management integrated circuit (PMIC) or another component external to the processor. In yet other examples, power management operations to be performed by PCU 817 may be implemented within BIOS or other system software.

Various I/O devices 814 may be coupled to first interface 810, along with a bus bridge 818 which couples first interface 810 to a second interface 820. In some examples, one or more additional processor(s) 815, such as coprocessors, high throughput many integrated core (MIC) processors, GPGPUs, accelerators (such as graphics accelerators or digital signal processing (DSP) units), field programmable gate arrays (FPGAs), or any other processor, are coupled to first interface 810. In some examples, second interface 820 may be a low pin count (LPC) interface. Various devices may be coupled to second interface 820 including, for example, a user interface 822 (such as a keyboard, mouse, touchscreen, or other input devices), communication devices 826 (such as modems, network interface devices, or other types of communication devices that may communicate through a computer network), and storage circuitry 828. Storage circuitry 828 may be one or more non-transitory machine-readable storage media as described below, such as a disk drive or other mass storage device which may include instructions/code and data 830. Further, an audio I/O 824 may be coupled to second interface 820. Note that other architectures than the point-to-point architecture described above are possible. For example, instead of the point-to-point architecture, a system such as multiprocessor system 800 may implement a multi-drop interface or other such architecture.

While some of the systems and solutions described and illustrated herein have been described as containing or being associated with a plurality of elements, not all elements explicitly illustrated or described may be utilized in each alternative implementation of the present disclosure. Additionally, one or more of the elements described herein may be located external to a system, while in other instances, certain elements may be included within or as a portion of one or more of the other described elements, as well as other elements not described in the illustrated implementation. Further, certain elements may be combined with other components, as well as used for alternative or additional purposes in addition to those purposes described herein.

Further, it should be appreciated that the examples presented above are non-limiting examples provided merely for purposes of illustrating certain principles and features and not necessarily limiting or constraining the potential embodiments of the concepts described herein. For instance, a variety of different embodiments can be realized utilizing various combinations of the features and components described herein, including combinations realized through the various implementations of components described herein. Other implementations, features, and details should be appreciated from the contents of this Specification.

Although this disclosure has been described in terms of certain implementations and generally associated methods, alterations and permutations of these implementations and methods will be apparent to those skilled in the art. For example, the actions described herein can be performed in a different order than as described and still achieve the desirable results. As one example, the processes depicted in the accompanying figures do not necessarily require the particular order shown, or sequential order, to achieve the desired results. In certain implementations, multitasking and parallel processing may be advantageous. Additionally, other user interface layouts and functionality can be supported. Other variations are within the scope of the following claims.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

With regard to this specification generally, unless expressly stated to the contrary, use of the phrases ‘at least one of’ and ‘one or more of’ refers to any combination of the named elements, conditions, activities, messages, entries, paging structures, or devices. For example, ‘at least one of X, Y, and Z’ and ‘one or more of X, Y, and Z’ is intended to mean any of the following: 1) at least one X, but not Y and not Z; 2) at least one Y, but not X and not Z; 3) at least one Z, but not X and not Y; 4) at least one X and at least one Y, but not Z; 5) at least one X and at least one Z, but not Y; 6) at least one Y and at least one Z, but not X; or 7) at least one X, at least one Y, and at least one Z.

Additionally, unless expressly stated to the contrary, the terms ‘first’, ‘second’, ‘third’, etc., are intended to distinguish the particular items (e.g., element, condition, module, activity, operation, claim element, messages, protocols, interfaces, devices, etc.) they modify, but are not intended to indicate any type of order, rank, importance, temporal sequence, or hierarchy. For example, ‘first X’ and ‘second X’ are intended to designate two separate X elements that are not necessarily limited by any order, rank, importance, temporal sequence, or hierarchy of the two elements, unless specifically stated to the contrary.

In the foregoing specification, a detailed description has been given with reference to specific exemplary embodiments. It will, however, be evident that various modifications and changes may be made thereto without departing from the broader spirit and scope of the disclosure as set forth in the appended claims. The specification and drawings are, accordingly, to be regarded in an illustrative sense rather than a restrictive sense. Furthermore, the foregoing use of “embodiment” and other exemplarily language does not necessarily refer to the same embodiment or the same example, but may refer to different and distinct embodiments, as well as potentially the same embodiment.

Embodiments of the mechanisms disclosed herein may be implemented in hardware, software, firmware, or a combination of such implementation approaches. Embodiments of this disclosure may be implemented, at least partially, as computer programs or program code executing on programmable systems comprising at least one processor, a storage system (including volatile and non-volatile memory and/or storage elements), at least one input device, and at least one output device.

The architectures presented herein are provided by way of example only and are intended to be non-exclusive and non-limiting. Furthermore, the various parts disclosed are intended to be logical divisions only and need not necessarily represent physically separate hardware and/or software components. Certain computing systems may provide memory elements in a single physical memory device, and in other cases, memory elements may be functionally distributed across many physical devices. In the case of virtual machine managers or hypervisors, all or part of a function may be provided in the form of software or firmware running over a virtualization layer to provide the disclosed logical function.

It is also important to note that the operations in the preceding flowcharts and diagrams illustrating interactions, illustrate only some of the possible activities that may be executed by, or within, computing system 100, 300, 400, 500, and 800 using the approaches disclosed herein for a multi-device host controller to perform emulation of embedded devices operating on various interconnects and selective autonomous management of the embedded devices. Some of these operations may be deleted or removed where appropriate, or these operations may be modified or changed considerably without departing from the scope of the present disclosure. In addition, the timing of these operations may be altered considerably. For example, the timing and/or sequence of certain operations (e.g., in FIGS. 5, 6A, 6B) may be changed relative to other operations to be performed before, after, or in parallel to the other operations, or based on any suitable combination thereof. The preceding operational flows have been offered for purposes of example and discussion. Substantial flexibility is provided by embodiments described herein in that any suitable arrangements, chronologies, configurations, and timing mechanisms may be provided without departing from the teachings of the present disclosure.

The following examples pertain to embodiments in accordance with this specification. The system, apparatus, method, and machine readable media embodiments can include one or a combination of the following examples.

Example C1 one or more machine readable media comprising instructions for execution that when executed by a multi-device host controller, cause the multi-device host controller to: emulate a first embedded device of a plurality of embedded devices of a computing system, and to emulate the first embedded device is to include generating a first descriptor based on a Universal Serial Bus (USB) protocol and on peripheral configuration information, and the peripheral configuration information is associated with the first embedded device and pre-programmed for the multi-device host controller. When executed by a multi-device host controller, the instructions further cause the multi-device host controller to provide the first descriptor to a software stack running on a processor of the computing system.

Example C2 comprises the subject matter of Example C1, and the first embedded device is configured to operate according to the USB protocol.

Example C3 comprises the subject matter of Example C1, and the first embedded device is configured to operate according to a first communication protocol that is different than the USB protocol.

Example C4 comprises the subject matter of Example C3, and the instructions, when executed cause the multi-device host controller further to: subsequent to sending the first descriptor to the software stack, receive first data from the first embedded device; generate second data by translating the first data from a first format associated with the first communication protocol to a second format associated with the USB protocol; and send the second data to the software stack.

Example C5 comprises the subject matter of any one of Examples C1-C4, and the first embedded device is physically connected to the multi-device host controller.

Example C6 comprises the subject matter of any one of Examples C1-C5, and the first descriptor is one of a device descriptor, a configuration descriptor, an interface descriptor, an endpoint descriptor, a companion descriptor, a class-specific descriptor, or a vendor-specific descriptor.

Example C7 comprises the subject matter of any one of Examples C1-C6, and the instructions, when executed cause the multi-device host controller further to determine, based on a capability indicator, whether the multi-device host controller supports autonomous device management of the first embedded device.

Example C8 comprises the subject matter of any one of Examples C1-C7, and the instructions, when executed cause the multi-device host controller further to take an action to autonomously manage the first embedded device based on one or more inputs received from one or more other embedded devices connected to the multi-device host controller.

Example C9 comprises the subject matter of any one of Examples C1-C8, and the instructions, when executed cause the multi-device host controller further to receive a first communication from the software stack requesting a configuration change to the first embedded device, and configure the first embedded device based at least in part on the first communication.

Example C10 comprises the subject matter of any one of Examples C1-C9, and the software stack includes a user mode device driver for the first embedded device.

Example A1 provides an apparatus that includes: an integrated circuit that, when coupled between an embedded device of a computing system and a processor of the computing system, is to: detect a first embedded device of a plurality of embedded devices connected to the integrated circuit, emulate the first embedded device by generating a first descriptor based on a Universal Serial Bus (USB) protocol and on first peripheral configuration information, and the first peripheral configuration information is associated with the first embedded device and pre-programmed in the integrated circuit; and provide the first descriptor to a first software stack running on the processor.

Example A2 comprises the subject matter of Example A1, and the first embedded device is configured to operate according to the USB protocol.

Example A3 comprises the subject matter of Example A1, and the first embedded device is configured to operate according to a first communication protocol that is different than the USB protocol.

Example A4 comprises the subject matter of Example A3, and the integrated circuit is further to: subsequent to sending the first descriptor to the first software stack, receive first data from the first embedded device; generate second data by translating the first data from a first format associated with the first communication protocol to a second format associated with the USB protocol; and send the second data to the first software stack.

Example A5 comprises the subject matter of any one of Examples A1-A4, and the first embedded device is physically connected to the integrated circuit.

Example A6 comprises the subject matter of any one of Examples A1-A5, and the first descriptor is one of a device descriptor, a configuration descriptor, an interface descriptor, an endpoint descriptor, a companion descriptor, a class-specific descriptor, or a vendor-specific descriptor.

Example A7 comprises the subject matter of any one of Examples A1-A6, and the integrated circuit is further to determine, based on a capability indicator, whether the integrated circuit supports autonomous device management of the first embedded device.

Example A8 comprises the subject matter of any one of Examples A1-A7, and the integrated circuit is further to take an action to autonomously manage the first embedded device based on one or more inputs received from one or more other embedded devices connected to the integrated circuit.

Example A9 comprises the subject matter of any one of Examples A1-A8, and the integrated circuit is further to receive a first communication from the first software stack requesting a configuration change to the first embedded device, and configure the first embedded device based at least in part on the first communication.

Example A10 comprises the subject matter of any one of Examples A1-A9, and the first software stack includes a USB kernel mode driver stack and a first user mode device driver loaded for the first embedded device.

Example A11 comprises the subject matter of any one of Examples A1-A10, and the integrated circuit is further to: detect a second embedded device of the plurality of embedded devices; emulate the second embedded device by generating a second descriptor based on the USB protocol and on second peripheral configuration information, and the second peripheral configuration information is associated with the second embedded device and pre-programmed in the integrated circuit; and provide the second descriptor to a second software stack.

Example A12 comprises the subject matter of Example A11, and the first embedded device is configured to operate according to the USB protocol, and the second embedded device is configured to operate according to a non-USB protocol.

Example A13 comprises the subject matter of any one of Examples A11-A12, and the second software stack includes a USB kernel mode driver stack and a second user mode driver loaded for the second embedded device.

Example A14 comprises the subject matter of any one of Examples A1-A13, and the first embedded device is an embedded display connected to the integrated circuit via an embedded Universal Serial Bus 2 version 2 (eUSB2v2) interconnect.

Example S1 provides a system that includes a processor, a plurality of embedded devices, and a multi-device host controller communicatively coupled between the processor and the plurality of embedded devices. The multi-device host controller is to: based on detecting a first embedded device operating according to a first communication protocol, generate first identification information for the first embedded device based on a second communication protocol and on first peripheral configuration information; and take an action to autonomously manage the first embedded device based on one or more inputs received from one or more other embedded devices of the plurality of embedded devices.

Example S2 comprises the subject matter of Example S1, and the multi-device host controller is further to: subsequent to sending the first identification information to a software stack, receive first data from the first embedded device; generate second data by translating the first data from a first format associated with the first communication protocol to a second format associated with the second communication protocol; and send the second data to the software stack.

Example S3 comprises the subject matter of any one of Examples S1-S2, and the first embedded device is physically connected to the multi-device host controller.

Example S4 comprises the subject matter of any one of Examples S1-S3, and the first identification information is included in a USB device descriptor.

Example S5 comprises the subject matter of any one of Examples S1-S4, and the multi-device host controller is further to determine, based on a capability indicator, whether the multi-device host controller supports autonomous device management of the first embedded device.

Example S6 comprises the subject matter of any one of Examples S1-S5, and the multi-device host controller is further to: receive a first communication from a software stack requesting a configuration change to the first embedded device; and configure the first embedded device based at least in part on the first communication.

Example S7 comprises the subject matter of any one of Examples S1-S6, and the multi-device host controller is further to send the first identification information to a software stack, and the software stack includes a user mode device driver for the first embedded device.

Example S8 comprises the subject matter of any one of Examples S1-S7, and the multi-device host controller is further to: based on detecting a second embedded device operating according to the second communication protocol, generate second identification information for the second embedded device based on the second communication protocol and on second peripheral configuration information; and provide the second identification information to a second software stack.

Example S9 comprises the subject matter of any one of Examples S1-S8, and the second communication protocol is a Universal Serial Bus (USB) protocol.

Example S10 comprises the subject matter of any one of Examples S1-S9, and the first embedded device is an embedded display connected to the multi-device host controller via an embedded Universal Serial Bus 2 version 2 (eUSB2v2) interconnect.

Example S11 comprises the subject matter of any one of Examples S1-S9, and the first communication protocol is an Inter Integrated Circuit (I2C) protocol, an Improved Inter Integrated Circuit (I3C) protocol, a serial peripheral interface (SPI) protocol, or a general purpose input/output (GPIO) protocol.

1. One or more machine readable media comprising instructions for execution that when executed by a multi-device host controller, cause the multi-device host controller to:
emulate a first embedded device of a plurality of embedded devices of a computing system, wherein to emulate the first embedded device is to include generating a first descriptor based on a Universal Serial Bus (USB) protocol and on peripheral configuration information, wherein the peripheral configuration information is associated with the first embedded device and pre-programmed for the multi-device host controller; and
provide the first descriptor to a software stack running on a processor of the computing system.

2. The one or more machine readable media of claim 1, wherein the first embedded device is configured to operate according to the USB protocol.

3. The one or more machine readable media of claim 1, wherein the first embedded device is configured to operate according to a first communication protocol that is different than the USB protocol.

4. The one or more machine readable media of claim 3, wherein the instructions, when executed cause the multi-device host controller further to:
subsequent to sending the first descriptor to the software stack, receive first data from the first embedded device;
generate second data by translating the first data from a first format associated with the first communication protocol to a second format associated with the USB protocol; and
send the second data to the software stack.

5. The one or more machine readable media of claim 1, wherein the first embedded device is physically connected to the multi-device host controller.

6. The one or more machine readable media of claim 1, wherein the first descriptor is one of a device descriptor, a configuration descriptor, an interface descriptor, an endpoint descriptor, a companion descriptor, a class-specific descriptor, or a vendor-specific descriptor.

7. The one or more machine readable media of claim 1, wherein the instructions, when executed cause the multi-device host controller further to:
determine, based on a capability indicator, whether the multi-device host controller supports autonomous device management of the first embedded device.

8. The one or more machine readable media of claim 1, wherein the instructions, when executed cause the multi-device host controller further to:
take an action to autonomously manage the first embedded device based on one or more inputs received from one or more other embedded devices connected to the multi-device host controller.

9. The one or more machine readable media of claim 1, wherein the instructions, when executed cause the multi-device host controller further to:
receive a first communication from the software stack requesting a configuration change to the first embedded device; and
configure the first embedded device based at least in part on the first communication.

10. The one or more machine readable media of claim 1, wherein the software stack includes a USB kernel mode driver stack and a user mode device driver loaded for the first embedded device.

11. An apparatus, comprising:
an integrated circuit that, when coupled between an embedded device of a computing system and a processor of the computing system, is to:
detect a first embedded device of a plurality of embedded devices connected to the integrated circuit;
emulate the first embedded device by generating a first descriptor based on a Universal Serial Bus (USB) protocol and on first peripheral configuration information, wherein the first peripheral configuration information is associated with the first embedded device and pre-programmed in the integrated circuit; and
provide the first descriptor to a first software stack running on the processor.

12. The apparatus of claim 11, wherein the integrated circuit is further to:
detect a second embedded device of the plurality of embedded devices;
emulate the second embedded device by generating a second descriptor based on the USB protocol and on second peripheral configuration information, wherein the second peripheral configuration information is associated with the second embedded device and pre-programmed in the integrated circuit; and
provide the second descriptor to a second software stack.

13. The apparatus of claim 12, wherein the first embedded device operates according to the USB protocol, wherein the second embedded device operates according to a non-USB protocol.

14. The apparatus of claim 11, wherein the integrated circuit is further to:
take an action to manage the first embedded device based on one or more data inputs received from one or more other embedded devices connected to the integrated circuit.

15. The apparatus of claim 11, wherein the first embedded device is an embedded display connected to the integrated circuit via an embedded Universal Serial Bus 2 version 2 (eUSB2v2) interconnect.

16. A system comprising:
a processor;
a plurality of embedded devices; and
a multi-device host controller communicatively coupled between the processor and the plurality of embedded devices, wherein the multi-device host controller is to:
based on detecting a first embedded device operating according to a first communication protocol, generate first identification information for the first embedded device based on a second communication protocol and on first peripheral configuration information; and
take an action to autonomously manage the first embedded device based on one or more inputs received from one or more other embedded devices of the plurality of embedded devices.

17. The system of claim 16, wherein the multi-device host controller is further to:
based on detecting a second embedded device operating according to the second communication protocol, generate second identification information for the second embedded device based on the second communication protocol and on second peripheral configuration information; and
provide the second identification information to a second user mode device driver for the second embedded device.

18. The system of claim 17, wherein the multi-device host controller is further to:
determine, based on at least one capability indicator, that the multi-device host controller supports autonomous device management of the first embedded device and the second embedded device.

19. The system of claim 16, wherein the second communication protocol is a Universal Serial Bus (USB) protocol.

20. The system of claim 16, wherein the first communication protocol is an Inter Integrated Circuit (I2C) protocol, an Improved Inter Integrated Circuit (I3C) protocol, a serial peripheral interface (SPI) protocol, or a general purpose input/output (GPIO) protocol.
